(19) United States
(12) Patent Application Publication
(10) Pub. No.: US 2024/0193705 A1
(43) Pub. Date: Jun. 13, 2024

(54) SOCIAL PROCESSING METHOD AND RELATED DEVICE

(71) Applicant: TENCENT TECHNOLOGY (SHENZHEN) COMPANY LIMITED, Shenzhen (CN)

(72) Inventors: Fei CHENG, Shenzhen (CN); Kai Kang, Shenzhen (CN); Yunlong Zhu, Shenzhen (CN); Wenhao Xiao, Shenzhen (CN)

(73) Assignee: TENCENT TECHNOLOGY (SHENZHEN) COMPANY LIMITED, Shenzhen (CN)

(21) Appl. No.: 18/587,285

(22) Filed: Feb. 26, 2024

Related U.S. Application Data
(63) Continuation of application No. PCT/CN23/87504, filed on Apr. 11, 2023.

(30) Foreign Application Priority Data
Jul. 6, 2022 (CN) 2022107936017

(51) Int. Cl. G06Q 50/00; G06T 13/40; H04L 51/52

(52) U.S. Cl. CPC G06Q 50/01; G06T 13/40; H04L 51/52

(57) ABSTRACT

A social processing method includes displaying a session interface of a social session comprising N social objects, N being an integer greater than 1, and each social object having an avatar, the avatar being an image configured for interacting with other social objects through an interaction behavior; obtaining configuration information, the configuration information being information on M avatars to-be-displayed of N avatars, and M being an integer less than or equal to N; and displaying the M avatars in the session interface according to the configuration information.

### CROSS-REFERENCE TO RELATED APPLICATIONS

This application is a continuation application of International Application No. PCT/CN2023/087504 filed on Apr. 11, 2023, which claims priority to Chinese Patent Application No. 202210793601.7, filed with the China National Intellectual Property Administration on Jul. 6, 2022, the disclosures of each being incorporated by reference herein in their entireties. processing.

### FIELD

The disclosure relates to the field of internet technologies, and specifically, to social

### BACKGROUND

With the development of internet technologies, a social object may configure an avatar to represent himself in a social scene, and display the avatar in the social scene; however, a current display policy for the avatar is relatively single and fixed, and cannot adapt to an increasingly complex social scene. Especially in a social session scene in which a plurality of social objects participate, display and application of the avatar are relatively rigid and inflexible.

### SUMMARY

Some embodiments provide a social processing method and a related device.

Some embodiments provide a social processing method, including: displaying a session interface of a social session comprising N social objects, N being an integer greater than 1, and each social object having an avatar, the avatar being an image configured for interacting with other social objects through an interaction behavior; obtaining configuration information, the configuration information being information on M avatars to-be-displayed of N avatars, and M being an integer less than or equal to N; and displaying the M avatars in the session interface according to the configuration information.

Some embodiments provide a social processing apparatus, including: at least one memory configured to store program code; and at least one processor configured to read the program code and operate as instructed by the program code, the program code comprising: display code configured to cause at least one of the at least one processor to display a session interface of a social session comprising N social objects, N being an integer greater than 1, and each social object having an avatar; processing code configured to cause at least one of the at least one processor to obtain configuration information, the configuration information being information on M avatars to-be-displayed of N avatars and M being an integer less than or equal to N; and wherein the display code is further configured to cause at least one of the at least one processor to display the M avatars in the session interface according to the configuration information.

Some embodiments provide a computer-readable storage medium, display a session interface of a social session comprising N social objects, N being an integer greater than 1, and each social object having an avatar, the avatar being an image configured for interacting with other social objects through an interaction behavior; obtain configuration information for the avatar, the configuration information being information on M avatars to-be-displayed of N avatars; and M being an integer less than or equal to N; and display the M avatars in the session interface according to the configuration information

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1A is a schematic diagram of a structure of a social processing system according to some embodiments.

FIG. 1B is a schematic diagram of a structure of a social processing system according to some embodiments.

FIG. 2 is a schematic flowchart of a social processing method according to some embodiments.

FIG. 3A is a schematic diagram of a session interface according to some embodiments.

FIG. 3B is a schematic diagram of an avatar with configuration information to be displayed according to some embodiments.

FIG. 3C is a schematic diagram of calling out a menu including a resident option and a blocking option according to some embodiments.

FIG. 3D is a schematic diagram of displaying an avatar in a target area according to some embodiments.

FIG. 3E is a schematic diagram of triggering display of a target area according to some embodiments.

FIG. 3F is a schematic diagram of displaying a target area including a display position according to some embodiments.

FIG. 4A is a schematic diagram of enlarged display of a resident avatar according to some embodiments.

FIG. 4B is a schematic diagram of bold display of an object identifier corresponding to a resident avatar according to some embodiments.

FIG. 4C is a schematic diagram of configuring an avatar with resident display according to some embodiments.

FIG. 4D is a schematic diagram of blocking an avatar according to some embodiments.

FIG. 4E is a schematic diagram of performing display management on an avatar according to some embodiments.

FIG. 4F is a schematic diagram of performing display management on an avatar according to some embodiments.

FIG. 4G is a schematic diagram of performing display management on an avatar according to some embodiments.

FIG. 4H is a schematic diagram of changing a display manner of an avatar according to some embodiments.

FIG. 5 is a schematic flowchart of a social processing method according to some embodiments.

FIG. 6A is a schematic diagram of an interaction option list according to some embodiments.

FIG. 6B is a schematic diagram of an interaction option list according to some embodiments.

FIG. 6C is a schematic diagram of special reminder interaction according to some embodiments.

FIG. 6D is a schematic diagram of displaying a separate session interface according to some embodiments.

FIG. 6E is a schematic diagram of displaying a separate session interface according to some embodiments.

FIG. 6F is a schematic diagram of displaying an adding interface according to some embodiments.

FIG. 7 is a schematic flowchart of displaying an avatar according to some embodiments.

FIG. 8A is a schematic diagram of a character action player displaying an avatar according to some embodiments.

FIG. 8B is a schematic diagram of displaying only one avatar floating layer according to some embodiments.

FIG. 8C is a schematic diagram of displaying two avatar floating layers according to some embodiments.

FIG. 8D is a schematic diagram of four avatar floating layers according to some embodiments.

FIG. 9 is a schematic diagram of a structure of a social processing apparatus according to some embodiments.

FIG. 10 is a schematic diagram of a structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Terms involved in some embodiments are introduced below:

1. Social client: A social client may refer to a social application (APP) or a social application. For example, the social client may include but is not limited to: an instant messaging APP, a map social APP, a content interaction APP, a game social APP, and the like; the social client may also refer to a website with a social capability, such as a social network site, a forum, and the like; and the social client may further refer to a subprogram (commonly referred to as a mini program) in an APP, such as a social mini program in the game APP, and the like.

2. A social session and a session interface: The social client may include a social session, and the social session may include a separate session and a group chat session. The separate session refers to a social session in which two social objects participate, and is configured for information exchange between the two social objects. The group chat session refers to a social session in which a plurality of (more than two) social objects participate, and is configured for information exchange in the plurality of social objects. A session interface is an interface that allows the social object to conduct the social session and presents information exchanged by the social object during the social session.

3. A social object and an avatar of the social object: The social object refers to an object who logs in through a social account and uses the social client. The avatar refers an image configured for representing the social object in the social client. A social object may personalize an avatar of the social object in the social client; and during the social session, the social object may vividly express mood and speaking tone of the social object, and interact with each of the other social objects through a body action and a face expression of the avatar. The avatar may be a 2D character image, a 3D character image, a comic character image, and the like.

4. Social attribute information of a social object: The social attribute information refers to data obtained by performing analysis processing on historical session data and historical exchange data generated by the social object in the social session. The social attribute information may include at least one of the following: a social activity level of the social object in the social session; an interaction frequency between the social object and each of the other social objects in the social session; and the interaction relationship between the social object and each of the other social objects in the social session.

The social activity level includes at least one of the following: (1) a quantity of messages transmitted by the social object in the social session in a preset time period. For example, the social object transmits 50 pieces of messages in the social session in one day. For another example, the social object transmits 555 pieces of messages in the social session in a preset time period (February 1, xx to March 1, xx). (2) Joining duration of the social object that joins the social session, that is, the joining duration refers to a time difference between a time point at which the social object starts to join the social session and a current system time; and for example, the social object joins the social session on January 30, yy, the current system time is February 10, yy, and the joining duration is 10 days. (3) Online duration of the social object. The online duration may refer to duration that the last time the social object logs in to the social client and remains online, or may also refer to cumulative duration that the social object historically logs in to the social client and remains online. (4) A quantity of times that the social object participates in a social topic in the social session.

The interaction frequency between the social object and each of the other social objects in the social session includes at least one of the following: (1) A frequency at which the social object likes each of the other social objects, for example, a social object 1 likes a social object 2 10 times a day. (2) A frequency at which the social object comments on each of the other social objects, for example, the social object 1 comments on the social object 2 5 times every half hour. (3) A frequency at which the social object enters social space of each of the other social objects to perform visiting, for example, the social object 1 enters social space of the social object 2 to perform visiting once every half hour. (4) A frequency at which the social object performs information exchange with each of the other social objects in the session interface. Information exchange may be: the i^{th} social object repeatedly issues a special reminder to each of the other social objects in the session interface, and the special reminder may be @ each of the other social objects. For example, the social object 1 @ the social object 2 every 5 minutes in the session interface; or the information exchange may be: the i^{th} social object mentions a specific social object a plurality of times in transmitting a social message in the session interface. For example, the social object 1 mentions the social object 2 every 5 minutes in the session interface. “Mention” may mean that the social message that is transmitted includes a nickname, a name, an avatar, an identifier, and the like of the mentioned social object.

The interaction relationship between the social object and each of the other social objects in the social session includes any one of the following: (1) an order relationship between a message transmitted by the social object in the social session and messages transmitted by each of the other social objects in the social session, where the order relationship may be an order in which the message is transmitted, or a context order; and (2) a time difference relationship between a transmitting time point at which the social object transmits the message in the social session and a transmitting time point at which each of the other social objects transmits the message in the social session. A transmitting time point at which the i^{th} social object transmits the message in the social session is 15: 00. A transmitting time point at which the target social object transmits the message in the social session is 15: 01. Then a time difference relationship between the two is 1s.

It is to be understood that in various embodiments, various types of data related to the social object are involved, such as an object identifier, the social attribute information, the avatar, and the like of the social object. When embodiments are applied to specific products or technologies, permission or consent of the social object needs to be obtained, and the collection, use, and processing of related data comply with related laws, regulations, and standards of related countries and regions.

In various embodiments, displaying a session interface of a social session, the social session including N social objects, and each social object having an avatar of the social object; and N being an integer greater than 1; obtaining configuration information for the avatar, the configuration information being configured for configuring M to-be-displayed avatars in N avatars; and M being an integer and M being less than or equal to N; and displaying the M avatars in the session interface according to the configuration information. Information configuration is performed on an avatar and the avatar is displayed, so that the avatar may be more flexibly used in a social scene (especially a social session scene), thereby meeting a personalized requirement of a social object.

An example in which a target social object using the social client is used. The target social object may refer to any social object in the social session; and the social processing solution is as follows:

(1) N social objects may be included in the social session, and each social object separately corresponds to an avatar of the social object. It may be understood that the target social object may be any one of the N social objects. The target social object may perform information configuration as required, thereby implementing flexible display and effective management of the avatar of the social object in the session interface of the social session. The configuration information includes, but is not limited to the following: \textcircled{1} Configure a quantity M of avatars of to-be-displayed social objects in the session interface; and for example, the target social object may be configured to display one avatar, two avatars, five avatars, and the like in the session interface by moving and clicking an object identifier of the social object. For another example, the target social object may set a preset condition, and automatically configure the quantity of avatars of the to-be-displayed social objects according to the social attribute information of the social object in the social session and the preset condition. \textcircled{2} Configure a display position of a to-be-displayed avatar in the session interface or adjust a display position of an avatar that has been displayed in the session interface; and for example, the target social object may display the to-be-displayed avatar in a target area of the session interface, or randomly display the avatar that needs to be displayed at different display positions (for example, an avatar 1 is displayed on a left side of the session interface, and an avatar 2 is displayed on a right side of the session interface) of the session interface. For another example, the target social object may move the displayed avatar to a display position 1, and in response to a movement operation, a display position of the displayed avatar may be configured as the display position 1. \textcircled{3} Configure a display manner of the to-be-displayed avatar, and the display manner may include resident or non-resident. For example, the target social object may configure an avatar of the social object that is interested in or the avatar of the social object that much attention is payed to as resident. Resident means that the avatar is displayed at a specific display position for a long time and does not change with specific factors (except for configuration of the display manner of the avatar by the social object); or resident means that after exiting the session interface, the avatar is still displayed at a corresponding display position when entering the session interface again. Non-resident means that the display position of the avatar may change to different display positions as specific factors change. For example, when an avatar is newly added, the newly added avatar may replace a display position of a non-resident avatar; and the newly added avatar cannot replace a display position of a resident avatar. \textcircled{4} The avatar displayed in the session interface may be blocked. If the target social object does not want to see an avatar of a specific social object, the target social object may block the avatar of the social object through removal operations such as clicking, moving, and touching and holding. Blocking means not displaying the avatar of the social object in the session interface. Only when configuration of the blocked avatar is changed through configuration information, the blocked avatar is redisplayed in the session interface.

(2) The target social object may interact with the corresponding social object through the M avatars displayed in the session interface. The target social object may awaken some quick interaction options through operations such as touching and holding and clicking the avatar. Through these interaction options, quick interaction with the social object of the avatar may be implemented. The interaction may include but is not limited to: adding an object, entering a separate session interface (to be specific, starting private chat through an avatar) between two social objects, joining virtual space in which the avatar is located, joining a mini program of the social object corresponding to the avatar in a social client, and visually issuing a special reminder to the social object corresponding to the avatar in the session interface. The virtual space refers to an environment built to simulate reality (such as a living environment and an island) and allow the avatar to be displayed and interacted with. For example, the virtual space may simulate a real living environment, and the avatar may simulate life in the virtual space. The mini program in the social client may be understood as a subprogram in the social client, and an application that may be used without downloading and installation, for example, mini programs in the social client may be social updates, reading, music, and the like.

Through the foregoing social processing solution, information configuration may be performed on an avatar and the avatar may be displayed, so that the avatar may be more flexibly used in a social scene (especially a social session scene), thereby meeting a personalized requirement of the social object, improving flexibility of display of the avatar, and increasing fun of the social session. When avatars of a plurality of social objects are displayed in the session interface, comparison between the avatars may be further implemented, and the pursuit of personalized avatars by the social object is stimulated, thereby increasing a usage rate of the avatars; and in addition, the social object may quickly interact with each of the other social objects through the avatar, and a large quantity of operations hidden in the social object list interface are forwarded to the avatar, thereby shortening an interaction path of the social object, and improving interaction efficiency.

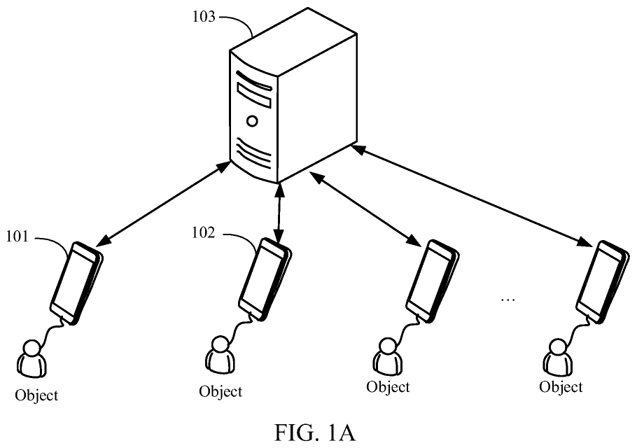

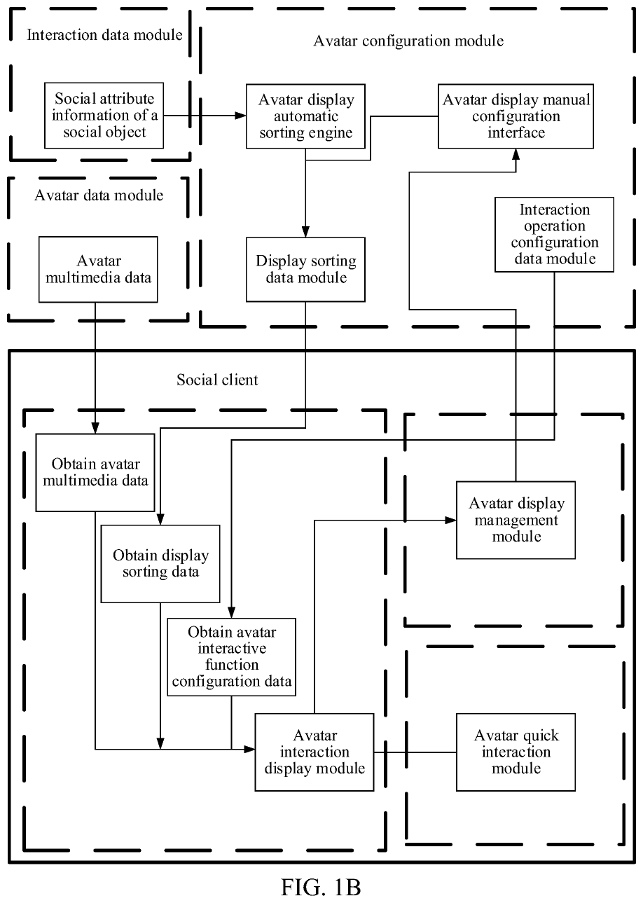

Next, related introduction is performed on the social processing system provided herein. FIG. 1A provides a social processing system according to some embodiments. As shown in FIG. 1A, the social processing system may include a computer device 101, a computer device 102, . . . , and a server 103. A quantity of computer devices is not limited herein. Certainly, a quantity of servers may also be more than one, and the quantity of servers is still not limited herein. The computer device 101 and the server 103 in the social processing system may be directly or indirectly connected in a wired or wireless communication manner; and the computer device 101 and the computer device 102 may exchange information through the server 103.

There are social clients running in the computer device 101 and the computer device 102; and the social object may log in to the social client to create an avatar of the social object. In some embodiments, a character action player is configured in the social client, and the character action player may be configured to display the avatar of the social object according to multimedia data of the avatar. The social object involved in embodiments may be a user who uses the social client; and the computer device may be a terminal device, and the computer device may include but is not limited to a smartphone, a tablet computer, a notebook computer, a desktop computer, a smart speaker, a smart watch, a vehicle-mounted terminal, a smart wearable device, and the like.

The server 103 may correspond to the social client, and is a server that provides technical support for a service provided by the social client. The server 103 may store object information (such as an object identifier) of the social object, multimedia data of the avatar of the social object, historical social information of the social object, and the like.

The server 103 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. Cloud computing refers to a delivery mode and a usage mode of IT infrastructure, which refers to obtaining required resources through the network in an on-demand and easily scalable manner; and broadly defined cloud computing refers to a delivery mode and a usage mode of a service, which refers to obtaining required services through the network in an on-demand and easily scalable manner. The services may be IT, software, internet-related, or other services. Cloud computing is a product of development and integration of conventional computer and network technologies such as grid computing, distributed computing, parallel computing, utility computing, network storage, virtualization, and load balancing. Cloud computing develops rapidly with the development of the internet, a real-time data flow, diversification of connected devices, and a requirement for a search service, a social network, mobile commerce, and open collaboration. Different from the previous parallel distributed computing, emergence of cloud computing conceptually promotes revolutionary changes in the entire internet mode and enterprise management mode.

Cloud storage is a new concept developed based on the concept of cloud computing. A distributed cloud storage system (abbreviated as a storage system below) is a storage system that combines many different types of storage devices (storage devices are also referred to as storage nodes) in a network through application software or an application interface based on cluster application, a grid technology, a distributed storage file system, and other functions, so that the storage devices work in coordination with each other to jointly provide data storage and service access functions to the outside. Currently, a storage method for the storage system is to create a logical volume. When creating the logical volume, physical storage space is allocated to each logical volume. The physical storage space may include disks of a specific storage device or several storage devices. The client stores data on a specific logical volume. In other words, the data is stored on a file system. The file system divides data into many parts. Each part is an object. The object not only includes data but also includes additional information such as a data identity. The file system separately writes each object into a physical storage space of the logical volume, and the file system records storage location information of each object, so that when the client requests access to data, the file system may allow the client to access the data according to the storage location information of each object. A process in which the storage system allocates physical storage space to the logical volume is that according to capacity estimation (the estimation often has a large margin relative to an actual capacity of a to-be-stored object) of objects stored in the logical volume and grouping of a redundant array of independent disk (RAID), the physical storage space is divided into strips in advance, and one logical volume may be understood as one stripe, thereby allocating physical storage space to the logical volume.

In some embodiments, using the computer device 101 and the server 103, the social processing process may be as follows:

(1) A target social object logs in to a social client in the computer device 101, and triggers entry into a session interface of a specific social session. The session interface includes N social objects, and object identifiers and avatars separately corresponding to the N social objects.

(2) The target social object may personalize the avatar of the social object that the target social object wants to display. It is assumed that any social object in the N social objects is represented as an i^{th} social object, and an object identifier of the i^{th} social object is triggered by touching and holding, double clicking, and the like. In response to a trigger operation for the object identifier of the i^{th} social object, an avatar of the i^{th} social object may be configured as the to-be-displayed avatar, and a data obtaining request may be transmitted to the server 103. The data obtaining request carries the object identifier of the i^{th} social object, and the data obtaining request is configured for obtaining multimedia data of the avatar of the i^{th} social object.

(3) After receiving the data obtaining request, the server 103 obtains the multimedia data of the avatar of the i^{th} social object according to the object identifier of the i^{th} social object, and transmits the multimedia data of the avatar of the i^{th} social object to the social client in the computer device 101.

(4) According to the foregoing (2) (3), the computer device 101 may obtain the multimedia data of each avatar of the M to-be-displayed avatars, and may display the avatars of the M social objects based on the multimedia data of each avatar in the session interface. After displaying the M avatars, the target social object may manage display of the M avatars. For example, through a display management operation, the M avatars may be partially displayed in the session interface or the avatar hidden in the M avatars may be redisplayed, and the like. The avatar is hidden means that the avatar is not displayed due to the display management operation or due to a range limit of a display area. The hidden avatar may be redisplayed through the display management operation, or may be redisplayed by switching to allow the hidden avatar to enter a range of the display area. When wanting to interact with any social object in the M social objects, the target social object may click on the avatar of the social object (such as a social object 1) that the target social object wants to interact with. The target social object may initiate an interaction operation on the avatar of the social object 1, and the computer device 101 quickly interacts with the social object 1 in response to the interaction operation on the avatar of the social object 1.

In some embodiments, using the computer device 101 and the server 103, the social processing process may be as follows:

(1) A target social object logs in to a social client in the computer device 101, and triggers entry into a session interface of a social session. The session interface includes N social objects, and object identifiers and avatars separately corresponding to the N social objects.

(2) The social client in the computer device 101 may send a data obtaining request to the server 103. The data obtaining request is configured for obtaining social attribute information of the N social objects. After receiving the data obtaining request, the server 103 obtains, in response to the data obtaining request, the social attribute information of the N social objects, and transmits the social attribute information of the N social objects to the social client in the computer device 101.

(3) The social client in the computer device 101 receives the social attribute information of the N social objects, determines whether the social attribute information of the N social objects meets a preset condition, and determines the avatars of the corresponding social object whose social attribute information meets the preset condition as the M to-be-displayed avatars.

(4) The social client of the computer device 101 may send the avatar obtaining request to the server 103. The avatar obtaining request may be configured for requesting multimedia data of the M to-be-displayed avatars. The avatar obtaining request carries the object identifier of the social object corresponding to the to-be-displayed avatar.

(5) After receiving the avatar obtaining request, the server 103 may obtain the multimedia data of the corresponding to-be-displayed avatar according to the object identifier of the social object corresponding to the to-be-displayed avatar, and return the multimedia data of the to-be-displayed avatar to the social client of the computer device 101.

(6) After receiving the multimedia data of the to-be-displayed avatar, the social client of the computer device 101 may display the M avatars in the session interface based on the multimedia data of the to-be-displayed avatar.

It should be understood that the server 103 may automatically determine the avatars of the to-be-displayed M social objects according to the set preset condition and the social attribute information of the N social objects, and save the M to-be-displayed avatars. The computer device 101 may directly obtain the to-be-displayed avatar and the corresponding multimedia data from the server 103. The social client in the computer device 101 may display the M avatars according to the multimedia data of the M to-be-displayed avatars.

FIG. 1B illustrates a schematic diagram of a structure of a social processing system according to some embodiments. The social processing system shown in FIG. 1B includes a social client in a computer device and a plurality of processing modules of a server. The plurality of processing modules of the server include: an interaction data module, an avatar data module, and an avatar configuration module.

Interaction data module: may provide social attribute information of the social object in the session interface. The social attribute information may include at least one of the following: a social activity level (such as transmitting a message in a preset time period by the social object, a social activity level of the social object that has recently spoken, and the like) of the social object in the social session, and an interaction relationship between the social object and each of the other social objects in the social session.

Avatar data module: stores the multimedia data of the avatar of the to-be-displayed social object, and may be called by the social client to display the avatar of the social object. The multimedia data may include, but is not limited to: dressing information of the avatar, a static avatar image, a dynamic avatar image, a sound animation, and a video animation. The dressing information may include a face feature, makeup (such as hairstyle), clothing, and the like.

Avatar configuration module: may provide an automatic sorting engine for display of the avatar, an avatar display manual configuration interface, an interaction operation configuration data module, and a display sorting data module that are required in the social session.

Avatar display automatic sorting engine: running an algorithm module, where the avatar display automatic sorting engine may obtain the social attribute information of the social object in the interaction data module, and calls the algorithm module according to the social attribute information of the social object to automatically calculate the M to-be-displayed avatars in the session interface and display order data of the M avatars; and then display order data of the M avatars is recorded into the display sorting data module. An algorithm policy is stored in the algorithm module. The algorithm policy may screen out, for example, a social object whose recent social activity level meets an activity threshold, a social object who transmits a message in a preset time period, and a social object who recently has an interaction relationship with each of the other social objects such as an @ reminder and a quote, or other policies that may screen out a social object with a highest probability of interaction in the future. Based on the algorithm policy, the M to-be-displayed avatars in the session interface may be calculated according to the social attribute information of the social object.

Avatar display manual configuration interface: may be configured to receive data generated after operation is performed by the avatar display management module in the social client, and also record the data into the display arrangement data module for the social client to call. The interaction operation configuration data module is configured to provide an interaction option for a social object corresponding to the avatar, and configuration data such as changes in the avatar in the interaction process. The interaction operation configuration data module may be configured to subsequently optimize and expand an interaction function corresponding to the required interaction option.

A social client in the computer device: provides an avatar interaction display module, an avatar display management module, and an avatar-based quick interaction module.

Avatar interaction display module: may obtain the display order data of the M avatars recorded in the display sorting data module, and then display the M avatars in the social session based on the display order data of the M avatars recorded in the display sorting data module.

Avatar display management module: provides the social object with a way to personalize and manage the displayed M avatars, for example, touching and holding a specific avatar to display only the avatar, touching and holding again to display the M avatars, configuring a resident avatar, manually adjusting a display position at which the avatar is displayed, and the like; and the data generated when the social object operates on the displayed avatar may be recorded to the foregoing display arrangement data module. Avatar-based quick interaction module: may be configured to quickly interact with the social object of the avatar.

Through the foregoing social processing system, information configuration is performed on an avatar and the avatar is displayed, so that the avatar may be more flexibly used in a social scene (especially a social session scene), thereby meeting a personalized requirement of the social object, improving flexibility of display of the avatar, and increasing fun of the social session. The social object further provides efficient management of the displayed avatar in the session interface. In addition, the social object may quickly interact with each of the other social objects through the avatar, and a large quantity of operations hidden in the social object list interface are forwarded to the avatar, thereby shortening an interaction path of the social object, facilitating more convenient interaction between social objects, and improving interaction efficiency. In addition, the server includes a plurality of processing modules, each processing module separately implements corresponding functions, and cooperates to complete the avatar that needs to be displayed in the configuration information of the social object and display the avatar, which is more efficient and easy to maintain.

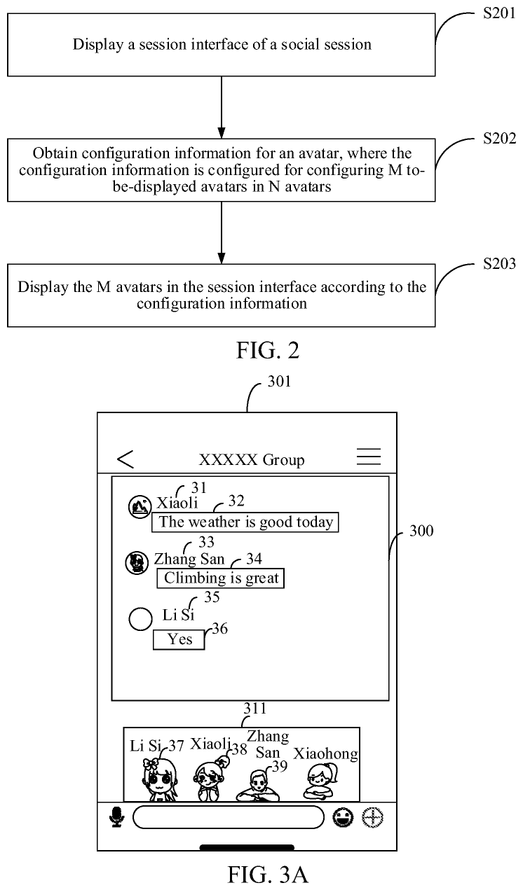

Next, the social processing method is described in detail. FIG. 2 is a schematic flowchart of a social processing method according to some embodiments. The social processing method may be performed by a computer device, or by a client in a computer device; and The social processing method provided in some embodiments may include the following operations S201 to S203.

S201: Display a session interface of a social session, where the social session includes N social objects, and each social object has an avatar of the social object; and N is an integer greater than 1, and the avatar of the social object is an image configured for interacting with each of the other social objects through an interaction behavior.

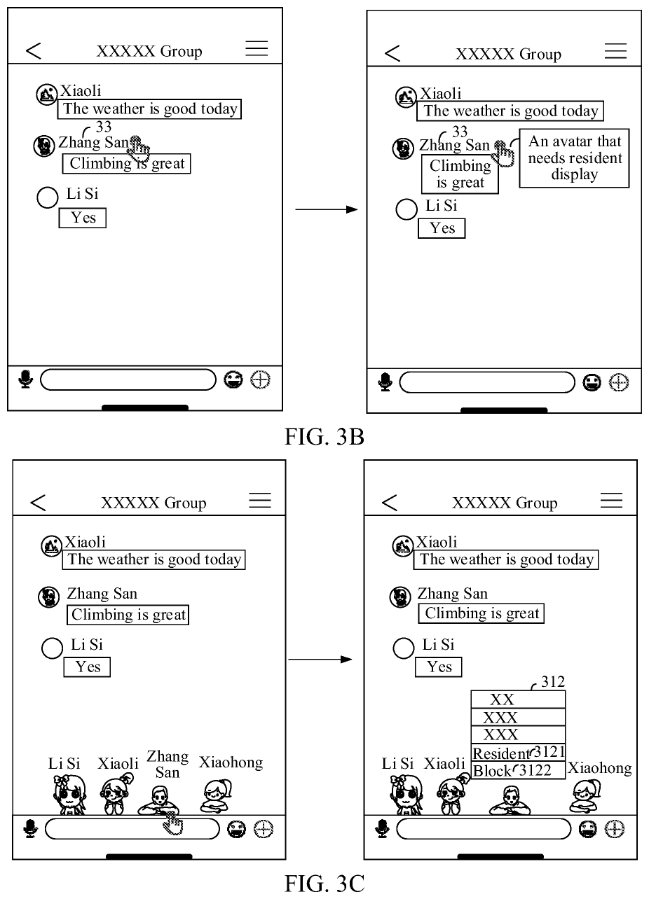

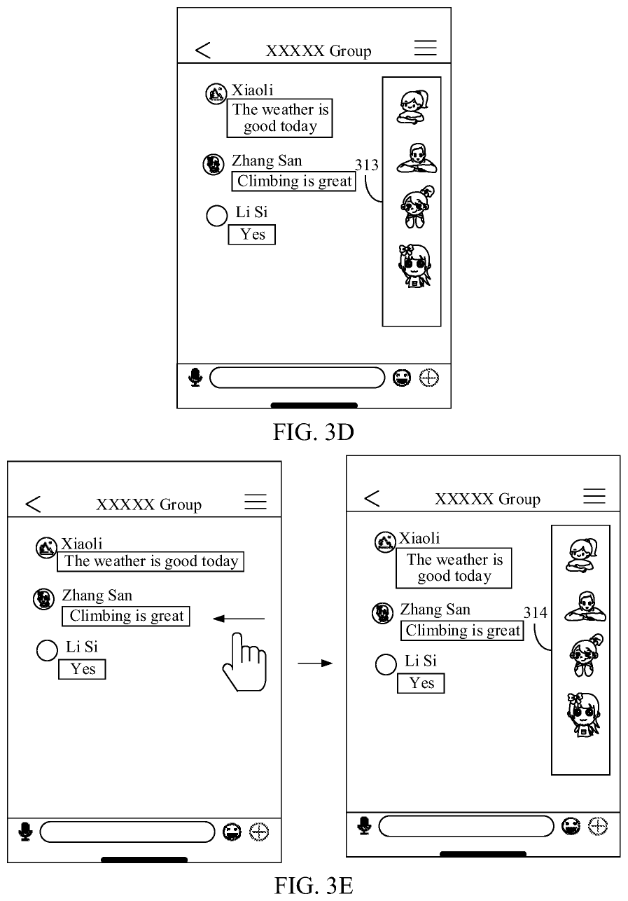

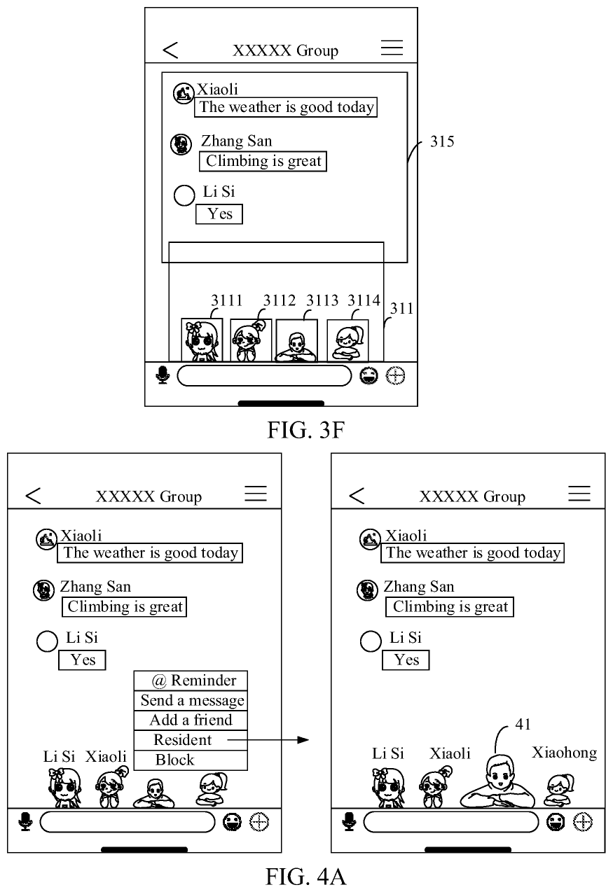

The social session may be a separate session, a group chat session, or a session initiated by a multi-object discussion group (a quantity of social objects is greater than 2). Correspondingly, the session interface of the social session may be a session interface of the separate session, a session interface of the group chat session, or a session interface of the multi-object discussion group; and all N social objects may send messages in the session interface and interact with, in the session interface, each of the other social objects that are in the session interface. For example, the session interface 301 shown in FIG. 3A includes: a group chat name “XXXXX Group”, and an object identifier 31 and a social message 32 of a social object “Xiaoli”, an object identifier 33 and a social message 34 of a social object “Zhang San”, and an object identifier 35 and a social message 36 of a social object “Li Si” are displayed in the session area 300 of the session interface 301. The avatar may be a 2D virtual character, a 3D character, or a cartoon character.

An interaction behavior of the avatar may vividly express mood and speaking tone of the corresponding social object, and interact with each of the other social objects through interaction behaviors such as a body action, a face expression, and the like of the avatar in the session interface. The avatar may be a 2D character image, a 3D character image, a cartoon character image, and the like, or may be other images other than characters. This is not limited herein.

The session interface is located in the social client, and any social object may set an avatar of the social object in the social client when logging in to the social client. For example, in FIG. 3A, an avatar possessed by the social object “Li Si” is an avatar 37, an avatar possessed by the social object “Xiaoli” is an avatar 38, and an avatar possessed by the social object “Zhang San” is an avatar 39.

202: Obtain configuration information for the avatar, where the configuration information is configured for configuring M to-be-displayed avatars in N avatars; and M is an integer and M is less than or equal to N. M may be 4, 5, 6, or even more. The configuration information may be set in advance, or configured in real time. Any social object may personalize the avatar according to a personalized requirement of the social object. The M avatars may include the avatar of the target social object. Certainly, the M avatars may not include the avatar of the target social object. The target social object refers to an object requesting personalized settings. It should be understood that the target social object may perform personalized settings for the avatar.

The computer device obtains the configuration information for the avatar in the following manners:

(1) Object identifiers of N social objects are displayed in the session interface. The social objects may quickly configure the to-be-displayed avatar through the object identifiers of the social objects in the social session. It is assumed that any one of the N social objects is represented as an i^{th} social object, and i is an integer and i is less than or equal to N; and the obtaining configuration information for the avatar may be: when the target social object triggers the object identifier of the i^{th} social object, the computer device receives a trigger operation performed on the object identifier of the i^{th} social object, and configures the avatar of the i^{th} social object as the to-be-displayed avatar based on the trigger operation. The trigger operation may include any one of the following: clicking the object identifier of the i^{th} social object, and moving the object identifier of the i^{th} social object in the session interface; touching and holding the object identifier of the i^{th} social object; and calling out a menu through the object identifier of the i^{th} social object, and selecting a to-be-displayed option from the menu. The object identifiers may include but are not limited to: a nickname and an avatar. For example, as shown in FIG. 3B, the social object touches-and-holds the object identifier 33 of the social object “Zhang San”, and the computer device receives the touching and holding operation performed on the object identifier 33 of the social object “Zhang San”, and configures the social object “Zhang San” as the to-be-displayed avatar. In some embodiments, prompt information may be displayed in the session interface. The prompt information is configured for prompting to configure the avatar of the social object “Zhang San” as the to-be-displayed avatar. In FIG. 3B, the prompt information is the “to-be-displayed avatar”.

(2) The social object has transmitted a message in the session interface and/or interacted with each of the other social objects in the session interface; and in this case, the computer device may configure information for the avatar according to the social attribute information of the social object. The computer device may obtain the social attribute information of the i^{th} social object, and determine whether the social attribute information of the i^{th} social object meets the preset condition. If the computer device determines that the social attribute information of the i^{th} social object meets the preset condition, the computer device configures the avatar of the i^{th} social object as the to-be-displayed avatar. The social attribute information of the i^{th} social object includes at least one of the following: a social activity level of the i^{th} social object in the social session; an interaction frequency between the i^{th} social object and each of the other social objects in the social session; and an interaction relationship between the i^{th} social object and each of the other social objects in the social session.

A. The social attribute information of the i^{th} social object includes: a social activity level (for example, the social activity level is 90%, 20%, and the like) of the i^{th} social object in the social session; and the social activity level of the i^{th} social object in the social session includes at least one of the following: a quantity of messages transmitted by the i^{th} social object in the social session in a preset time period; joining duration of the i^{th} social object that joins the social session; online duration of the i^{th} social object; and a quantity of times that the i^{th} social object participates in a social topic in the social session. The preset time period may be, for example, “February 1, xx to March 1, xx”, one hour, half an hour, and the like.

In this case, the configuring an avatar of the i^{th} social object as a to-be-displayed avatar in a case that the social attribute information of the i^{th} social object meets a preset condition may be: configuring the avatar of the i^{th} social object as the to-be-displayed avatar in a case that the social activity level of the i^{th} social object in the social session is greater than an activity threshold. The activity threshold may be set as required, for example, the activity threshold is 90%, 95%, and the like.

B. The social attribute information of the i^{th} social object includes: an interaction frequency between the i^{th} social object and each of the other social objects in the social session; and the interaction frequency between the i^{th} social object and each of the other social objects in the social session includes at least one of the following: a frequency at which the i^{th} social object likes each of the other social objects; a frequency at which the i^{th} social object comments on each of the other social objects; a frequency at which the i^{th} social object enters social space of each of the other social objects to perform visiting; and a frequency at which the i^{th} social object performs message exchange with each of the other social objects in the session interface.

In this case, the configuring an avatar of the i^{th} social object as a to-be-displayed avatar in a case that the social attribute information of the i^{th} social object meets a preset condition may be: configuring the avatar of the i^{th} social object as the to-be-displayed avatar in a case that the interaction frequency between the i^{th} social object and each of the other social objects in the social session is greater than a frequency threshold; otherwise, the avatar of the i^{th} social object is not the to-be-displayed avatar; and the frequency threshold may be set as required.

C. Social attribute information of the i^{th} social object includes: an interaction relationship between the i^{th} social object and each of the other social objects in the social session, where the interaction relationship between the i^{th} social object and each of the other social objects in the social session includes any one of the following:

an order relationship between a message transmitted by the i^{th} social object in the social session and messages transmitted by each of the other social objects in the social session; and for each of the other social objects, the target social object is used as an example. The message transmitted by the i^{th} social object in the social session and the message transmitted by the target social object in the social session are in a contextual relationship or in a chronological order. In other words, the message transmitted by the i^{th} social object in the social session is transmitted before the message transmitted by the target social object in the social session. For example, in FIG. 3A, the i^{th} social object is the social object “Xiaoli”, who first transmits the message 32 in the session interface, and the target social object is the social object “Zhang San”, who later transmits the message 34 in the session interface.

A time difference relationship between a transmitting time point at which the i^{th} social object transmits the message in the social session and a transmitting time point at which each of the other social objects transmits the message in the social session. A transmitting time point at which the i^{th} social object transmits the message in the social session is 15: 10. A transmitting time point at which the target social object transmits the message in the social session is 15: 13. Then a time difference relationship between the two is 3s.

In this case, the configuring an avatar of the i^{th} social object as a to-be-displayed avatar in a case that the social attribute information of the i^{th} social object meets a preset condition may be: configuring an avatar of the i^{th} social object as a to-be-displayed avatar if a latest message transmitted by the i^{th} social object in the social session is in a preset order range in a message flow of the social session. The preset order range may be set as required. For example, the preset order range is the latest two pieces of messages in the message flow of the social session. In FIG. 3A, the latest message 33 transmitted by the social object “Zhang San” in the social session is located in the range of the latest two pieces of messages in the message flow of the social session, and then it is determined that the avatar of the social object “Zhang San” is configured as the to-be-displayed avatar.

In some embodiments, the avatar of the i^{th} social object is configured as the to-be-displayed avatar in a case that a time difference between a transmitting time point at which the i^{th} social object transmits a latest message in the social session and a transmitting time point at which a target social object in the social session transmits a latest message is in a preset time range, where the involved target social object is an object requesting the configuration information, and the target social object is any one of each of the other social objects. For example, the preset time range is 0s to 1.5s. A transmitting time point at which the i^{th} social object transmits the message in the social session is 15: 00. A transmitting time point at which the target social object transmits the message in the social session is 15: 01. Then a time difference relationship between the two is 1s. If the time difference relationship is in the preset time range, the avatar of the i^{th} social object is determined as the to-be-displayed avatar.

In some embodiments, the obtaining configuration information for the avatar may be further: the computer device may sort the avatars of the N social objects according to the social attribute information of the N social objects, and configure the avatars of the social objects whose sorting result meets the preset condition as the to-be-displayed avatar. For example, the social attribute information is the social activity level, and the preset condition is that the avatars of the M social objects are taken according to the social activity level in descending order; and the computer device may sort the avatars of the N social objects according to the social activity level of the N social objects in descending order, to obtain a sorting result, and takes the avatars of the top M social objects from the sorting result and configures the avatars as the to-be-displayed avatars.

(3) The computer device may directly obtain the personalized settings for the avatar from the server. The server determines whether the social attribute information of the N social objects in the social session meets the preset condition, and configures the avatar of the social object whose social attribute information meets the preset condition as the to-be-displayed avatar. The server determines whether the social attribute information of the N social objects in the social session meets the preset condition, and configures the avatar of the social object whose social attribute information meets the preset condition as the to-be-displayed avatar. Refer to the foregoing detailed descriptions, and details are not described herein again.

In some embodiments, the obtaining configuration information for the avatar may be further: predicting a future interaction probability between any social object and each of the other social objects according to the social attribute information of the N social objects, and configuring the avatar of the social object whose future interaction probability meets an interaction condition as the to-be-displayed avatar. For example, the social attribute information of the i^{th} social object includes an interaction frequency at which the i^{th} social object interacts with the target social object, and the future interaction probability between the i^{th} social object and the target social object is predicted according to an interaction frequency at which the i^{th} social object interacts with the target social object; the higher the interaction frequency, the higher the future interaction probability; and if the future interaction probability between the i^{th} social object and the target social object is greater than a threshold, the avatar of the i^{th} social object may be configured as the to-be-displayed avatar, and otherwise the avatar of the i^{th} social object is not the to-be-displayed avatar.

In some embodiments, in addition to the M to-be-displayed avatars, the target social object may further configure a display manner of the M avatars and the avatars that need to be blocked according to preference information of the target social object. Let any avatar of the M avatars be a j^{th} avatar, and j is an integer and j is less than or equal to M. A display manner of the avatar of the social object that the target social object is interested in or wants to pay attention to is configured as resident display. When the configuration information is configured for configuring the display manner of the M avatars, the obtaining the configuration information for the avatar may be: the computer device may receive a resident operation performed on the j^{th} avatar, and configure the display manner of the j^{th} avatar as the resident display based on the resident operation. The resident operation may include one or more of the following: clicking the j^{th} avatar; touching and holding the j^{th} avatar; and calling out a menu through the j^{th} avatar, and selecting a resident option from the menu. For example, as shown in FIG. 3C, the target social object may touch-and-hold the j^{th} image to call out a menu 312, and the menu 312 includes a resident option 3121. The target social object may select the resident option 3121 from the menu. In this case, the computer device may receive a resident operation performed on the j^{th} avatar.

The target social object may block an avatar of a social object that the target social object is not interested in or does not want to pay attention to. When the configuration information is further configured for configuring the avatar that needs to be blocked, blocking means that the avatar is not displayed in the session interface. The obtaining configuration information for the avatar may be: receiving a removal operation performed on the j^{th} avatar; and configuring, based on the removal operation, the j^{th} avatar as the avatar that needs to be blocked, where the removal operation includes any one of the following: clicking the j^{th} avatar; moving the j^{th} avatar in the session interface; touching and holding the j^{th} avatar; and calling out a menu through the j^{th} avatar, and selecting an option that needs to be blocked from the menu. For example, as shown in FIG. 3C, the target social object may touch-and-hold the j^{th} avatar to call out a menu 312, and the menu 312 includes a blocking option 3122. The target social object may select the blocking option 3122 from the menu. In this case, the computer device may receive a blocking operation performed on the j^{th} avatar. The foregoing clicking may be single clicking, double clicking, or more times of clicking.

S203: Display the M avatars in the session interface according to the configuration information.

In some embodiments, the configuration information is configured for configuring an area in which the M avatars are displayed, and the computer device may display the M avatars in a target area of the session interface. The target area includes any one of the following: any area obtained by dividing the session interface; and an area presented following the session interface but independent of the session interface. Any area may refer to an upper area, a lower area, a left-side area, and a right-side area in the session interface, an upper area of a text input box in the session interface, and the like; and for example, in FIG. 3A, a target area is an input box upper area 311 in the session interface, and four avatars are displayed in the input box upper area 311. For another example, as shown in FIG. 3D, the target area may be a right-side area 313 in the session interface, and four avatars are displayed in the right-side area 313. The area that is presented following the session interface but is independent of the session interface may be, for example, a window, a floating area, and the like that are presented following the session interface but are independent of the session interface.

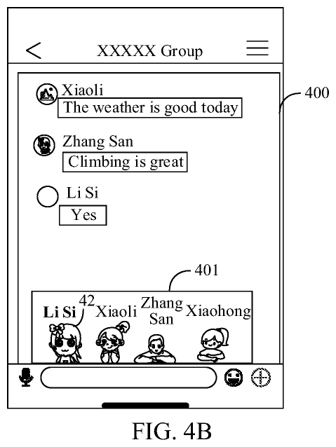

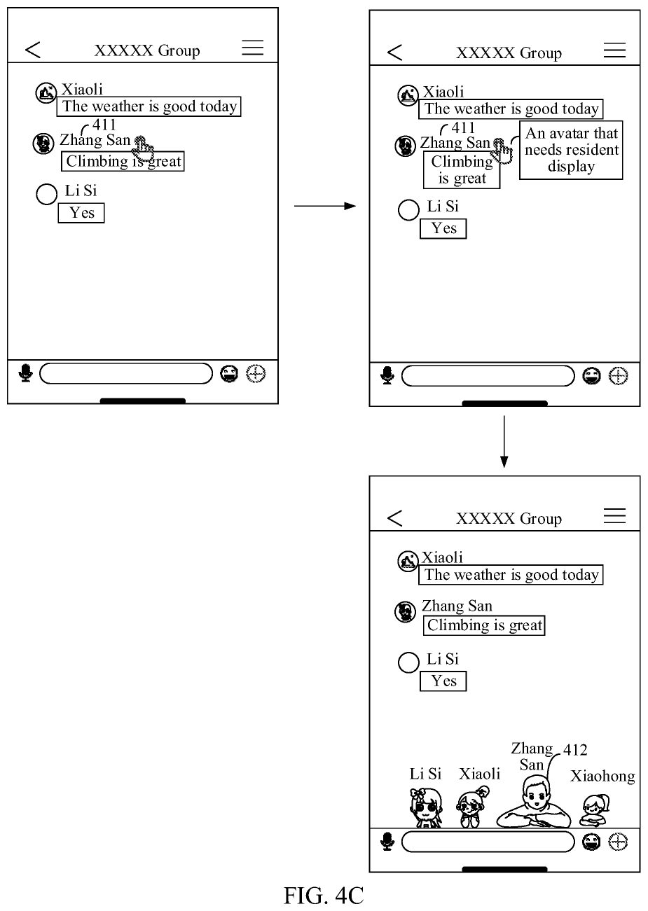

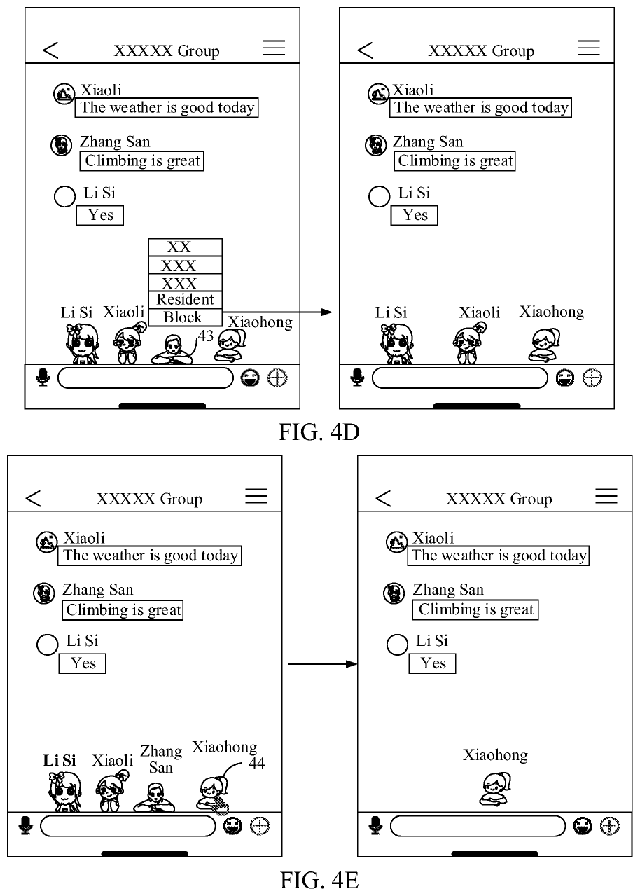

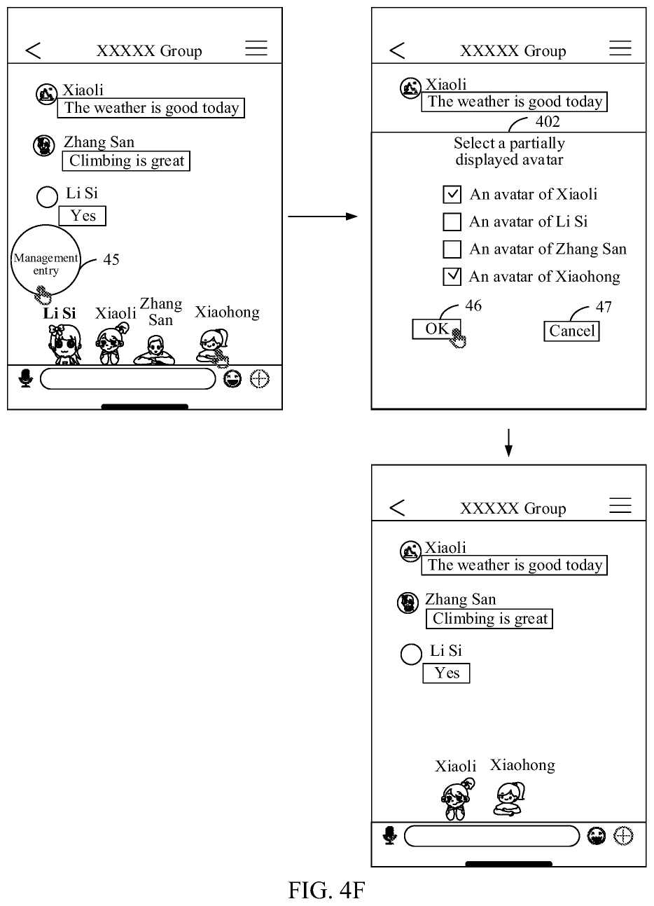

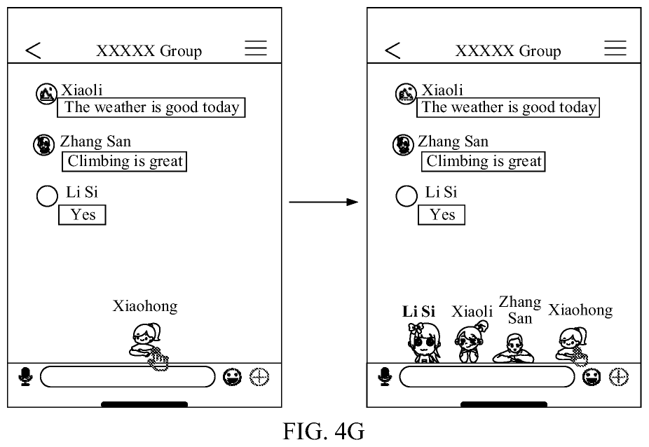

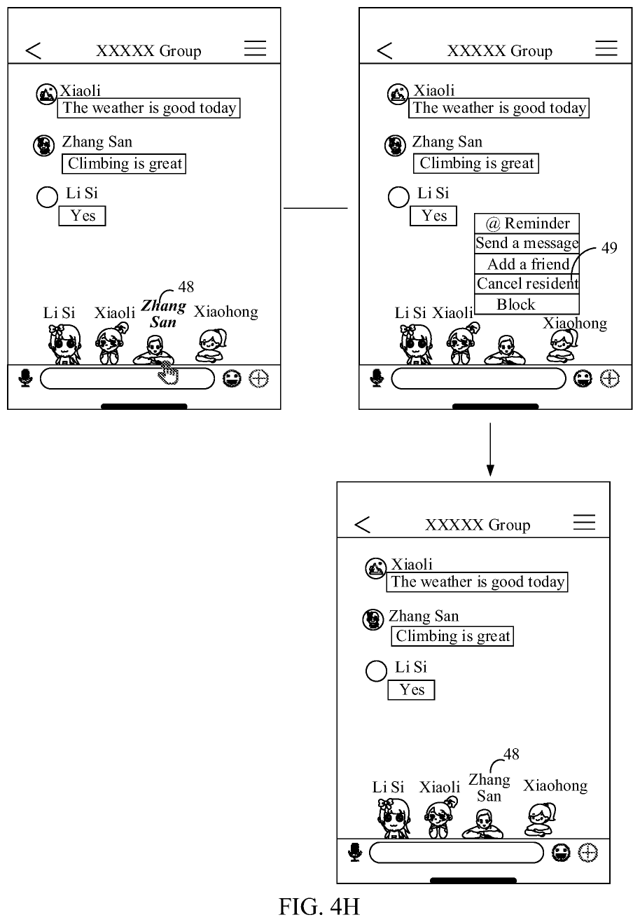

In some embodiments, the session interface may include a session area, and the session area is configured for displaying a message flow of the social session; and a position relationship between the target area and the session area includes any one of the following: \textcircled{1} The target area and the session area are two areas that are independent of each other. For example, in FIG. 3A, a message flow is displayed in a session area 300 of a session interface 301. The message flow includes a social message 32, a social message 34, and a social message 36. The target area 311 and the session area 300 are two areas that are independent of each other. \textcircled{2} There is an intersection between the target area and the session area. The so-called intersection means that the target area and the session area partially overlap or completely overlap with each other; and for example, as shown in FIG. 3F, there is an intersection between the session area 315 and the target area 311 in the session interface. \textcircled{3} The target area is located in the session area. For example, as shown in FIG. 4B, the target area 401 is located in a session area 400. \textcircled{4} The session area is located in the target area.

The display of the avatar in the target area and the display of the message flow in the session area are independent of each other and do not affect each other. In other words, the display of the avatar in the session area does not affect message exchange (such as sessions between social objects) between social objects and the display of the message flow.

In some embodiments, only the avatar may be displayed in the target area, or both the avatar and the object identifier may be simultaneously displayed in the target area; in addition, the object identifier of the social object displayed in the session area may be different from the identifier of the social object displayed in the target area; for example, what is displayed in the session area is an avatar (such as an avatar set by the social object in an instant messaging application) of a social object A; and in the target area, the avatar (that is, the avatar set by the social object is not displayed) corresponding to the social object A is directly displayed. Certainly, the computer device may also simultaneously display the M avatars in the session area and the target area. This is not limited herein.

In some embodiments, the target area is directly displayed by default. For example, in FIG. 3A and FIG. 3D, the target area may be directly displayed. In other words, the social object may directly see the target area in the session interface without the need for an area evocation operation; or the target area is hidden by default, and is triggered to be displayed in a case that there is an area evocation operation; and the foregoing default may be understood as default. As an implementation, the area evocation operation may be an operation of sliding in a target direction. For example, sliding to the right or left triggers display of the target area, and M avatars are displayed in the target area. As shown in FIG. 3E, the social object triggers display of the right-side area 314 by sliding to the right. For another example, sliding up or down triggers display of the target area. If the target area is a window, the social object may slide up to trigger display of the window. As another implementation, the area evocation operation may be an operation by inputting a specific gesture, for example, the specific gesture may be an OK gesture, an M gesture, a V gesture, and the like; and the area evocation operation is not limited herein.

The target area includes a plurality of display positions. For example, as shown in FIG. 3F, the target area 311 includes four display positions, namely, a display position 3111, a display position 3112, a display position 3113, and a display position 3114; and a process of displaying the M avatars in a target area of the session interface may be: respectively placing the M avatars at display positions in the target area for display. In FIG. 3F, four avatars may be separately placed at the display position 3111, the display position 3112, the display position 3113, and the display position 3114 for display.

A display order of the M avatars in the target area includes a random order or a fixed order; and in some embodiments, when the M avatars are separately placed at the display positions in the target area, the M avatars may be randomly placed at the display positions. In still another embodiment, a display order of the M avatars in the target area may be configured as a fixed order by the social object. For example, the social object may directly configure the display order to be displaying from left to right: an avatar 1, an avatar 2, an avatar 3, and an avatar 4. Then, when the four avatars are separately placed at the display positions in the target area, the four avatars are placed at the display positions in the target area from left to right in a fixed order. In yet another embodiment, the M avatars are determined through the social attribute information. The M avatars may be placed at the display positions from left to right for display according to the social attribute information. If the social attribute information is the interaction frequency, the M avatars are placed at the display positions from left to right according to the interaction frequency from high to low.

Further, some embodiments support dynamic adjustment for the display order of the M avatars in the target area, and implement more flexible and intelligent display of the avatars through dynamic adjustment. In some embodiments, the target social object may manually adjust the position of the avatar, to implement management of the display of the avatar. For example, the target social object may drag the target avatar to a target display position, and the computer device places the target avatar at the target display position in response to a drag operation. If the avatar originally exists at the target display position, the originally existing avatar is placed at a historical display position of the target avatar. In some embodiments, a display order of the M avatars in the target area may be automatically adjusted according to changes in the social attribute information of the social object. For example, the social attribute information is the social activity level; the M avatars include an avatar 1 of a social object 1 and an avatar 2 of a social object 2; a social activity level of the social object 1 changes from being less than a social activity level of the social object 2 to being greater than the social activity level of the social object 2; and the computer device may automatically adjust a display order of the avatar 1 and the avatar 2 in the M avatars: displaying the avatar 2 on the left side of the avatar 1, and displaying the avatar 1 on the left side of the avatar 2.

In some embodiments, in a process of displaying the M avatars in the target area of the session interface, the computer device may place the avatar of the target social object at the target display position in the target area, and place other avatars in the M avatars at other display positions according to the social attribute information. For example, in FIG. 3F, the avatar of the target social object is placed at the display position 3114 for display, and the other three avatars may be placed at the display position 3111, the display position 3112, and the display position 3113 for display according to the interaction frequency with the target social object; and in other words, the higher the interaction frequency with the target social object, the closer the avatar is to the target social object when being displayed. In this way, the social object may quickly view an avatar of a social object with whom the social object interacts more frequently.

In some embodiments, considering utilization efficiency of the session interface, a quantity of configured display positions is limited; and in this case, that the computer device separately places the M avatars at display positions in the target area for display may be: determining whether the quantity of display positions in the target area is greater than or equal to M, and in a case that the quantity of display positions in the target area is greater than or equal to M, which indicates that the display position may display the M avatars, respectively placing the M avatars at the display positions in the target area for display; and placing, in a case that the quantity of display positions in the target area is less than M, and the display positions cannot fully display the M avatars, some avatars in the M avatars at the display positions of the target area for display, and updating, in a case that a switching operation is detected, the avatars at the display positions, to switch display of the M avatars. More avatars may be displayed through flexible switching, and the social object may also view the avatar the social object wants to view.

In some embodiments, the switching operation may be an operation in which the target social object slides in the target direction; when the display positions are arranged from left to right (as shown in FIG. 3F), sliding in the target direction may be sliding leftward or sliding rightward; or when the display positions are arranged from top to bottom (as shown in FIG. 3D), sliding in the target direction may be sliding upward or sliding downward. In some embodiments, a switching operation may be an operation of automatically switching display of some avatars in the M avatars after a display time point reaches a preset time period. The preset time period may be set as required. For example, the preset time period may be 1 hour, 2 minutes, and the like. For example, the switching operation may be an operation of automatically switching display of some avatars in the M avatars after the display time point reaches 2 minutes. In this case, the avatars at the display positions are updated.

That some avatars in the M avatars are placed at the display positions of the target area for display may be: placing a random part of avatars in the M avatars at display positions in the target area for display; or selecting some avatars according to the social attribute information of the social objects corresponding to the M avatars and placing some avatars at the display positions of the target area for display. For example, avatars with a highest social activity level of the social object in the M avatars are placed at the display positions of the target area for display.

In some embodiments, the target social object may configure a display manner of the M to-be-displayed avatars as required. The configuration information is further configured for configuring a display manner of the M avatars; the display manner includes resident display; and the displaying the M avatars in the session interface according to the configuration information may be: highlighting, in the session interface, the avatars that need resident display in the M avatars according to the configuration information, and normally displaying the avatars that do not need resident display, where the highlighting includes any one or more of the following: enlarging and displaying the avatar that needs the resident display; displaying the avatar that needs the resident display in a target color; adding a resident prompt for the avatar that needs the resident display; and displaying the avatar that needs the resident display at a target position. For example, as shown in FIG. 4A, the configuration information is configured for configuring a display manner of the avatar 41 as resident display. Then the avatar 41 is enlarged and displayed in the session interface according to the configuration information, and the other three avatars are normally displayed. In some embodiments, the configuration information is configured for configuring a display manner of an avatar 1 as resident display. In the session interface, the avatar 1 is displayed in red according to the configuration information, and the remaining avatars in the M avatars are displayed in black. For another example, the configuration information is configured for configuring the display manner of the avatar 1 as resident display, and a resident prompt is added to the avatar 1 in the session interface according to the configuration information. The resident prompt is the text “resident”.

In some embodiments, when the M avatars are displayed according to the configuration information in the session interface, an object identifier of the social object corresponding to each avatar of the M avatars may be further displayed. In this case, the highlighting may include one or more of the following: the object identifier of the social object corresponding to the avatar that needs the resident display is displayed in bold, and the object identifier of the social object corresponding to the avatar that needs the resident display is displayed in a target color. For example, as shown in FIG. 4B, the configuration information is configured for configuring a display manner of an avatar 42 as resident display, and an object identifier “Li Si” corresponding to the avatar 42 is displayed in bold in the session interface according to the configuration information.

It should be understood that the resident avatar in the session interface is always displayed at a fixed position, and does not disappear due to exiting the session interface and then entering the session interface, and does not automatically disappear or change its position according to changes (for example, not participating in the ranking of the social activity level) in the social attribute information of the social object. In addition, when the to-be-displayed social object is not in the session interface, the desired social object may be quickly resident through the configuration information. For example, if the social object touches-and-holds the object identifier of the to-be-displayed social object, in response to the touching and holding operation on the object identifier of the social object, the avatar of the social object may be directly displayed in a resident manner in the session interface. In some embodiments, as shown in FIG. 4C, the target social object touches-and-holds an object identifier 411 of the social object, and in response to the touching and holding operation on the object identifier of the social object, configures a to-be-displayed avatar of the avatar of the social object, and performs resident display on an avatar 412 of the social object in the session interface. In other words, the avatar 412 is enlarged and displayed.

When the configuration information is configured for configuring the avatar that needs to be blocked, it is assumed that the configuration information is configured for configuring a j^{th} avatar in the M avatars that need to be blocked. The displaying the M avatars in the session interface according to the configuration information may be: deleting the j^{th} avatar from the session interface according to the configuration information. For example, as shown in FIG. 4D, the configuration information is configured for configuring the third avatar (namely, the avatar 43 in FIG. 4D) in the M avatars that need to be blocked, and deleting the avatar 43 from the session interface according to the configuration information. In other words, the avatar 43 is no longer displayed in the session interface.

In some embodiments, the session interface is located in the social client. For a resident avatar, the resident avatar may be placed in the service interface of the social client. In this way, after logging into the social client, the social object may quickly view the resident avatar and enter an associated interface associated with the resident avatar. In some embodiments, the avatar that needs the resident display is displayed in a service interface of the social client; and an associated interface of the triggered avatar may be displayed in a case that the avatar that needs the resident display displayed in the service interface is triggered, where the trigger operation may be clicking or touching and holding the resident avatar.

The service interface includes any one of the following: a homepage of the social client, a session list page of the social client, a function page of the social client, and a social relationship chain list page of the social client; and the associated interface of the triggered avatar includes any one of the following: a session interface between a social object corresponding to the triggered avatar and a trigger object, a session interface of a social group to which the social object corresponding to the triggered avatar belongs, and a corresponding session interface in a case that the triggered avatar is configured as resident display. The social relationship chain list page is a page configured for displaying one or more social objects that have an access relationship (such as being able to access space of the target social object) or a social interaction relationship (such as being able to directly send a message) with the target social object, which may be understood as a friend list page or a contact list page. A session interface between a social object corresponding to the triggered avatar and a trigger object may be understood as a private chat interface between the social object corresponding to the triggered avatar and the trigger object.

In some embodiments, the target social object may effectively manage the displayed M avatars. For example, the target social object may manage a quantity of displayed avatars as required, which may ensure cleanliness of the session interface to a certain extent; and the target social object manages, in response to a display management operation on a displayed avatar, the display of the M avatars, where the managing may include any one of the following: synchronously displaying the M avatars, synchronously hiding the M avatars, hiding some avatars in the M avatars, and redisplaying hidden avatars in the M avatars. The display management operation may be a touching and holding operation or a clicking operation on a specific avatar and a trigger operation (such as directly clicking the target area in which the M avatars are located to directly hide the M avatars) on a target area in which the M avatars are located, triggering a display management entry, and the like.

Using the avatar of the target social object included in the M avatars as an example, when the target social object touches-and-holds an avatar of the target social object, in response to the touching and holding operation on the avatar of the target social object, some avatars in the M avatars are hidden and displayed. For example, as shown in FIG. 4E, the avatar of the target social object is the avatar 44. The target social object touches-and-holds the avatar 44. In response to the touching and holding operation on the avatar 44, only the avatar 44 is displayed in the session interface. For example, as shown in FIG. 4F, the session interface includes a display management entry 45. The target social object clicks on the display management entry 45 and a display management interface 402. The M avatars, an OK option 46, and a cancel option 47 are displayed in the display management interface 402. When selecting to display an avatar (for example, selecting an avatar of Xiaoli and an avatar of Xiaohong) and clicks on the OK option 46, in response to a clicking operation of the OK operation, the target social object displays the two avatars selected for display in the session interface, to be specific, displays the avatar of Xiaoli and the avatar of Xiaohong. For another example, as shown in FIG. 4G, only the avatar of the target social object in the M avatars is displayed in the session interface. The target social object touches-and-holds the avatar of the target social object, and in response to the touching and holding operation (that is, touches-and-holds again) on the avatar of the target social object, redisplays (that is, displays four avatars) partially hidden avatars in the M avatars.

In some embodiments, the foregoing configuration information may be configured in real time. Therefore, when the configuration information changes, the avatar may be updated and displayed in the session interface according to the changed configuration information. In the session interface, the avatar is updated and displayed according to the changed configuration information. There are the following cases: \textcircled{1} When the target social object wants to redisplay the blocked avatar or the target social object wants to newly add a to-be-displayed avatar, information may be configured. Each time one to-be-displayed avatar is newly configured in the configuration information, a newly configured avatar is displayed in the session interface.

\textcircled{2} When the target social object wants to block a specific avatar, the avatar may also be deleted by configuring the information. Each time one avatar that needs to be blocked is newly configured in the configuration information, the avatar that has been displayed and needs to be blocked is deleted in the session interface.

It should be understood that to newly configure a to-be-displayed avatar and an avatar that needs to be blocked, refer to the to-be-displayed avatar that is correspondingly configured and the avatar that needs to be blocked.

\textcircled{3} When the target social object wants to change a display manner of the avatar, the information may also be configured. Each time a display manner of the avatar is changed in the configuration information, the avatar that has been displayed in the session interface is changed from resident display to non-resident display according to the change; or from non-resident display to resident display.

In some embodiments, a display manner changing operation performed on the j^{th} avatar is received; and a display manner of the j^{th} avatar is changed based on the display manner changing operation, where the display manner for the j^{th} avatar is changed from non-resident display to resident display, and the display manner changing operation includes any one of the following: clicking the j^{th} avatar; touching and holding the j^{th} avatar; and calling out a menu through the j^{th} avatar, and selecting a resident option from the menu. The display manner for the j^{th} avatar is changed from resident display to non-resident display, and the display manner changing operation includes any one of the following: clicking the j^{th} avatar; touching and holding the j^{th} avatar; and calling out a menu through the j^{th} avatar, and selecting a to-be-canceled resident option from the menu. For example, as shown in FIG. 4H, a display manner of an avatar 48 is resident display, and an object identifier “Zhang San” corresponding to the avatar 48 of the resident display is bolded and obliquely displayed; and the target social object calls out the menu through the avatar, and the menu displays cancel resident 49. In response to the display manner changing operation for the avatar 48, the display manner of the avatar 48 is changed from resident display to non-resident display, and according to the change, the display manner of the avatar 48 is changed to non-resident display in the session interface. In other words, as shown in FIG. 4H, the object identifier corresponding to the avatar 48 becomes normal (that is, neither being bolded nor being obliquely displayed).

In some embodiments, a session interface of a social session is displayed, the social session including N social objects, and each social object having an avatar of the social object; and N being an integer greater than 1; configuration information for the avatar is obtained, the configuration information being configured for configuring M to-be-displayed avatars in N avatars; and M being an integer and M being less than or equal to N; and M avatars are displayed in the session interface according to the configuration information, and information configuration is performed on an avatar and the avatar is displayed, so that the avatar may be more flexibly used in a social scene (especially a social session scene), thereby meeting a personalized requirement of a social object.

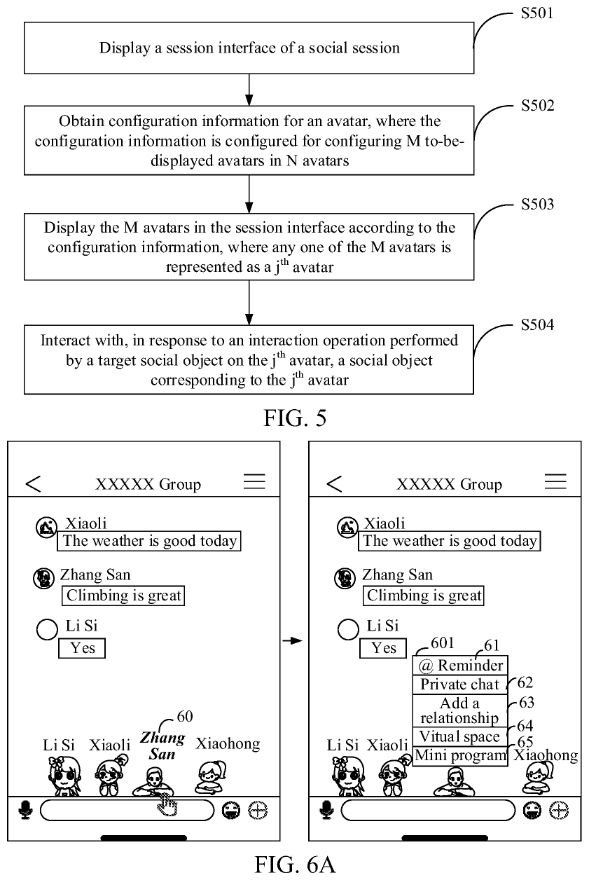

FIG. 5 is a schematic flowchart of another social processing method according to some embodiments. The social processing method may be performed by a computer device, or by a client in a computer device. The social processing method according to some embodiments may include the following steps S501 to S504.

S501: Display a session interface of a social session, where the social session includes N social objects, and each social object has an avatar of the social object; and N is an integer greater than 1.

S502: Obtain configuration information for the avatar, where the configuration information is configured for configuring M to-be-displayed avatars in N avatars; and M is an integer and M is less than or equal to N.

S503: Display the M avatars in the session interface according to the configuration information, where any one of the M avatars is represented as a j^{th} avatar, and j is an integer and j is less than or equal to M.

S504: Interact with, in response to an interaction operation performed by a target social object on the j^{th} avatar, a social object corresponding to the j^{th} avatar.

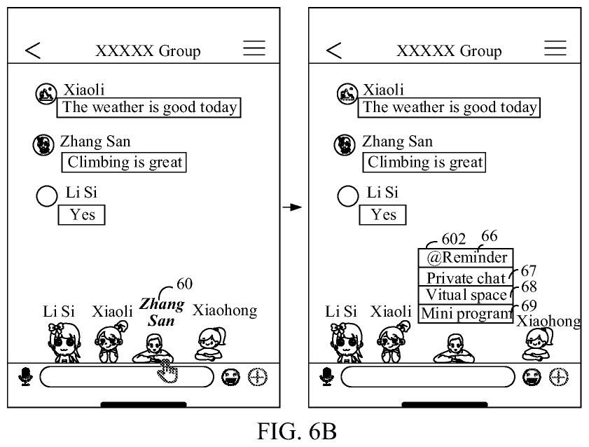

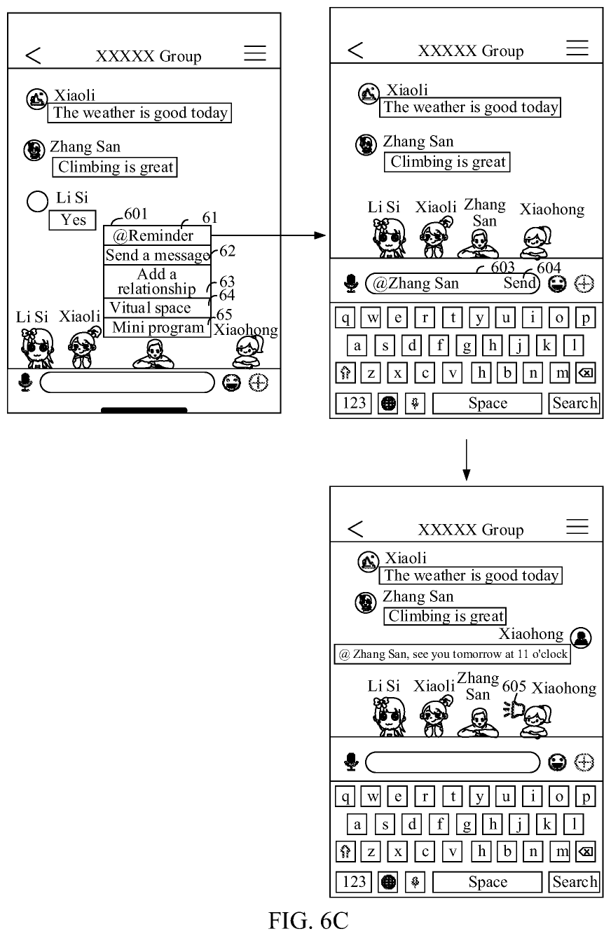

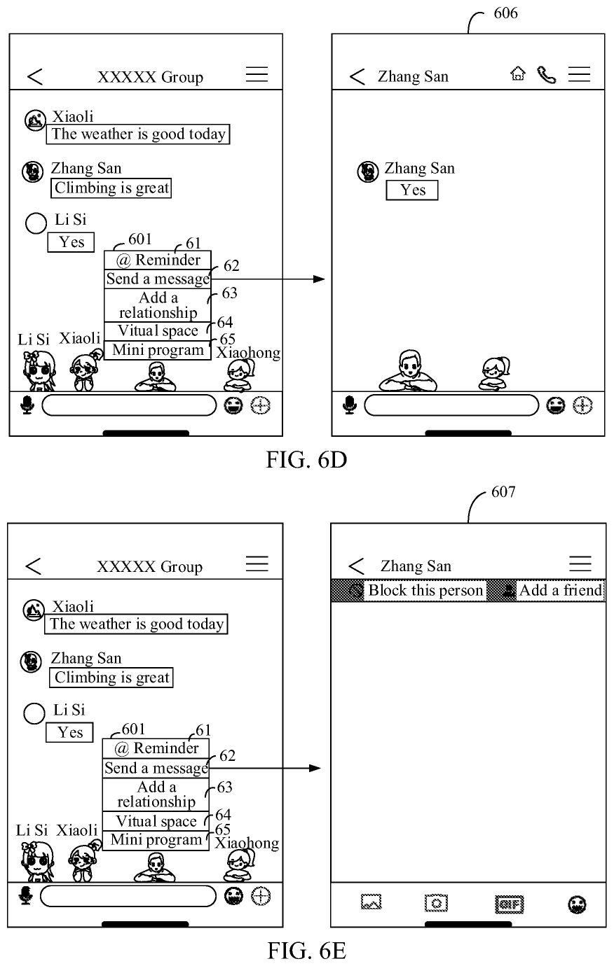

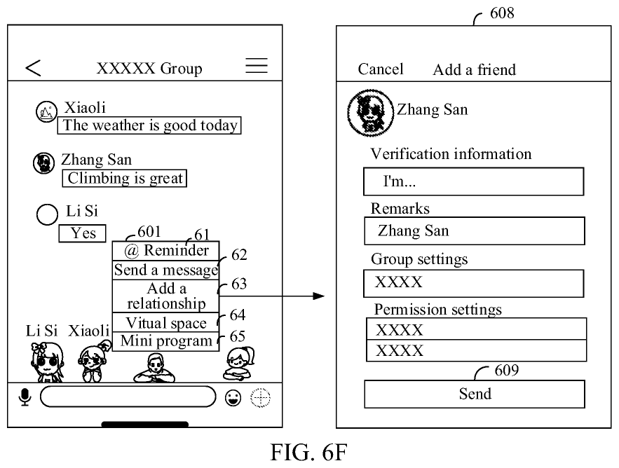

The interaction operation may include but is not limited to: touching and holding the j^{th} avatar, and double clicking the j^{th} avatar. The computer device displays an interaction option list in response to the interaction operation performed by the target social object on the j^{th} avatar, where the interaction option list includes one or more interaction options. The interaction option may include one of the following: a special reminder option, a separate session option, a relationship adding option, a virtual space option, and a mini program interaction option. The target social object may select the interaction option from the interaction option list, and interaction indicated by the selected interaction option is performed between the target social object and the social object corresponding to the j^{th} avatar. For example, as shown in FIG. 6A, when the target social object and the j^{th} avatar do not join social relationship chains of both parties, the target social object touches-and-holds the avatar 60, and displays the interaction option list 601 in response to the touching and holding operation on the avatar 60. The interaction option list 601 includes a special reminder option 61, a separate session option 62 (also referred to as a private chat or send message option), a relationship adding option 63, a virtual space option 64, and a mini program interaction option 65. The target social objects may select different interaction options to accordingly interact with each other as required. For another example, as shown in FIG. 6B, when the target social object and the j^{th} avatar join social relationship chains of both parties, the target social object touches-and-holds the avatar 60, and displays the interaction option list 602 in response to the touching and holding operation on the avatar 60. The interaction option list 602 includes a special reminder option 66, a separate session option 67, a virtual space option 68, and a mini program interaction option 69. The target social objects may select different interaction options to accordingly interact with each other as required.

(1) If the selected interaction option is the special reminder option, interaction indicated by the selected interaction option may be transmitting a social message in the session interface. The social message may include a special reminder identifier and an object identifier of the social object corresponding to the j^{th} avatar. The special reminder identifier may be @, #, *, and the like. This is not limited herein. In a specific implementation process, the computer device may automatically input, in response to the selected special reminder option, the special reminder identifier and the object identifier of the social object corresponding to the j^{th} avatar in a text input box of the social session; and when a message transmitting operation is received, a social message is transmitted in the session interface. The message transmitting operation may be clicking a transmitting option.

In some embodiments, after automatically inputting the special reminder identifier and the object identifier of the social object corresponding to the j^{th} avatar in the text input box of the social session, the target social object may continue to input text information in the text input box, and then trigger the transmitting option. Correspondingly, the computer device receives the message transmitting operation, and transmits the social message in the session interface. In this case, the social message may further include the text information. For example, as shown in FIG. 6C, when the target social object selects a special reminder option 61, in response to the selected special reminder option, a special reminder identifier “@” and an object identifier “Zhang San” of the social object corresponding to the avatar are automatically input into a text input box 603 of the social session. The target social object may input text information “See you tomorrow at 11 o'clock” in the text input box, and trigger a transmitting option 604; and when receiving the message transmitting operation, the computer device transmits the social message “@ Zhang San, see you tomorrow at 11 o'clock” in the session interface.

In some embodiments, after automatically inputting the special reminder identifier and the object identifier of the social object corresponding to the j^{th} avatar in the text input box of the social session, the target social object triggers the transmitting option. Correspondingly, the computer device receives the message transmitting operation, and transmits the social message in the session interface. In this case, the social message only includes the special reminder identifier and the object identifier of the social object corresponding to the j^{th} avatar; then, the target social object may input the text information in the text input box, and when receiving the message transmitting operation again, the computer device transmits the text information in the session interface; or the target social object directly inputs voice information by voice, and stops a voice input; and in this case, the computer device receives the message transmitting operation and transmits the voice information.

It should be understood that in some embodiments, a plurality of social objects may be further reminded through a plurality of avatars. For example, the target social object may perform interaction operations on the plurality of avatars displayed in the session interface, and in response to the interaction operation performed by the target social object on each avatar, may display an interaction option list corresponding to each avatar; and the target social object may select the special reminder option in the interaction option list corresponding to each avatar, automatically input, in response to the special reminder option selected in the interaction option list corresponding to each avatar, the special reminder identifier and the object identifier of the social object corresponding to each avatar in the text input box, and send a social message in the session interface when receiving the message transmitting operation. In this case, the social message includes: a reminder identifier+an object identifier of an avatar 1 corresponding to the social object, a reminder identifier+an object identifier of an avatar 2 corresponding to the social object, and the like; and for example, the social message includes @ Xiaoli and @ Xiaohong.

In some embodiments, when the M avatars are displayed above the text input box of the session interface according to the configuration information, the M avatars may change with activation of the text input box. The change may include one or more of the following: a shape, a size, a quantity, and a display position of the avatar. For example, when the text input box becomes larger, shapes of the M avatars may be changed from lying down to standing, the M avatars may be made smaller, and the M avatars may be displayed above the text input box, moved to the left side of the session interface for display, and the like.

(2) If the selected interaction option is a separate session option, through the separate session option, the separate session may be quickly initiated with the social object corresponding to the j^{th} avatar. The interaction indicated by the selected interaction option is displaying a separate session interface between the target social object and the social object corresponding to the j^{th} avatar. For example, as shown in FIG. 6D, the selected interaction option is a separate session option 62. In response to the separate session option 62 being selected, a separate session interface 606 (namely, a separate session interface corresponding to being added as a friend) between the target social object and the social object corresponding to the j^{th} avatar is displayed For another example, as shown in FIG. 6E, the selected interaction option is the separate session option 62, in response to the separate session option 62 being selected, an separate session interface 607 (namely, a separate session interface corresponding to not being added as a friend) between the target social object and the social object corresponding to the j^{th} avatar is displayed.

(3) If the selected interaction option is the relationship adding option, interaction indicated by the selected interaction option is adding the object identifier of the social object corresponding to the j^{th} avatar to a social relationship chain of the target social object, and the added social relationship chain may be quickly displayed. In a specific implementation, as shown in FIG. 6F, in response to the selected relationship adding option, an adding interface 608 is displayed, and the adding interface 608 includes a transmitting option 609. The target social object may trigger the transmitting option 609, and may send and add, in response to the trigger operation of the transmitting option 609, the social object corresponding to the j^{th} avatar (the social object “Zhang San” corresponding to the avatar in FIG. 6F) to the social relationship chain of the target social object. The social relationship chain may be understood as a friend list.

(4) If the selected interaction option is a virtual space option, the interaction indicated by the selected interaction option is displaying the virtual space (in other words, new virtual space may be constructed, and both the avatar corresponding to the j^{th} avatar and the target social object interact with each other in the virtual space) between the j^{th} avatar and the target social object, or the interaction indicated by the selected interaction option is that the target social object joins virtual space of the social object corresponding to the j^{th} avatar; or the interaction indicated by the selected interaction option is that the social object corresponding to the j^{th} avatar joins the virtual space of the target social object.

(5) If the selected interaction option is a mini program interaction option, the interaction indicated by the selected interaction option is that the target social object enters the mini program interface of the social object corresponding to the j^{th} avatar; or the interaction indicated by the selected interaction option is that the social object corresponding to the j^{th} avatar enters the mini program interface of the target social object. For example, if the mini program is reading, an avatar 1 may enter a reading interface of an avatar 2 through an interaction option of the mini program.

In some embodiments, following the interaction, an animation that matches the interaction may be output. By outputting the animation that matches the interaction, fun and liveliness of the social session may be enhanced. Following the interaction, a prompt animation that matches interactive content may be played in the session interface; or following the interaction, an avatar corresponding to the target social object or the j^{th} avatar is controlled to execute the animation that matches the interactive content. The animation that matches the interactive content may be: an expression of the avatar, a body action of the avatar, voice of the avatar, and the like that match the interactive content. For example, the interaction is sending a social message in the session interface, and the social message includes a special reminder identifier and an object identifier of the social object corresponding to the j^{th} avatar. In the session interface, the target social object @ the j^{th} avatar while holding a speaker. In FIG. 6C, there is a speaker 605 and @ the avatar “Zhang San” next to the avatar “Xiaohong”. For another example, the interaction is that the social object 1 transmits a message “Hello” to the social object 2. The avatar of the social object 1 and the avatar of the social object 2 may be displayed standing in the middle of the session interface, waving and making a sound of “hello”.

It should be understood that when transmitting a message in the session interface, the social object corresponding to any avatar in the M avatars may further insert an animated expression generated by the avatar of the social object into the message. In addition, when any avatar is activated, richer highlighting manners may be provided, for example, an animated sound may be played.

In some embodiments, each avatar corresponds to an interaction option list, and a display manner of the interaction option list may be flexibly changed according to each avatar. For example, the avatar 1 is standing, and an interaction option list corresponding to the avatar 1 may be displayed suspending around the avatar 1; and for another example, if the avatar 1 is lying down, an interaction option list corresponding to the avatar 1 may be displayed above the head of the avatar 1.

In some embodiments, a session interface of a social session is displayed, the social session including N social objects, and each social object having an avatar of the social object; and N being an integer greater than 1; configuration information for the avatar is obtained, the configuration information being configured for configuring M to-be-displayed avatars in N avatars; and M being an integer and M being less than or equal to N; and the M avatars are displayed in the session interface according to the configuration information; and Information configuration is performed on an avatar and the avatar is displayed, so that the avatar may be more flexibly used in a social scene (especially a social session scene), thereby meeting a personalized requirement of a social object. Further, in response to the interaction operation performed by the target social object on the j^{th} avatar, the target social object interacts with the social object corresponding to the j^{th} avatar, and rapid interaction may be implemented through the avatar.

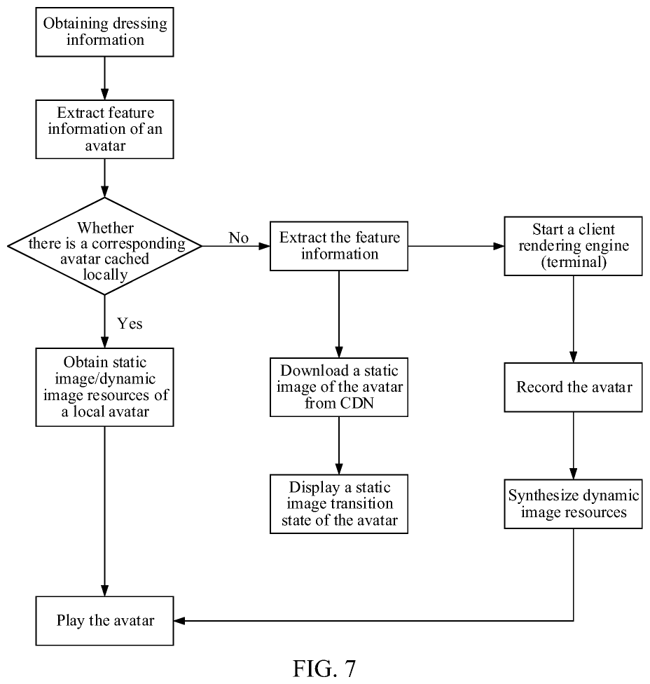

Next, how to display the M avatars in the session interface is described in detail below. FIG. 7 is a schematic flowchart of displaying M avatars according to some embodiments. A character action player is defined in a social client of a computer device, and the character action player provides a capability to record and display an avatar.

(1) After obtaining configuration information for the avatar, the social client in the computer device may determine M to-be-displayed avatars according to the configuration information, and then obtain dressing information of each avatar of the M avatars; and an example in which any one of the M avatars is used as a j^{th} avatar is used as an example.

(2) The social client in the computer device extracts feature information of a to-be-displayed j^{th} avatar from the dressing information, and determines whether there is a corresponding avatar cached locally in the social client based on the feature information of the j^{th} avatar.

(3) If it is determined that the to-be-displayed j^{th} avatar is cached locally, a static image or a dynamic image resource of the to-be-displayed j^{th} avatar cached locally is obtained; and then the character action player is called to play and display the j^{th} avatar based on the static image or the dynamic image resource of the to-be-displayed j^{th} avatar.

(4) If it is determined that the to-be-displayed j^{th} avatar is not cached locally, the feature information of the to-be-displayed j^{th} avatar is extracted; and then the static image corresponding to the feature information is downloaded from a content delivery network (CDN), and a transition state of the static image is displayed in the session interface.

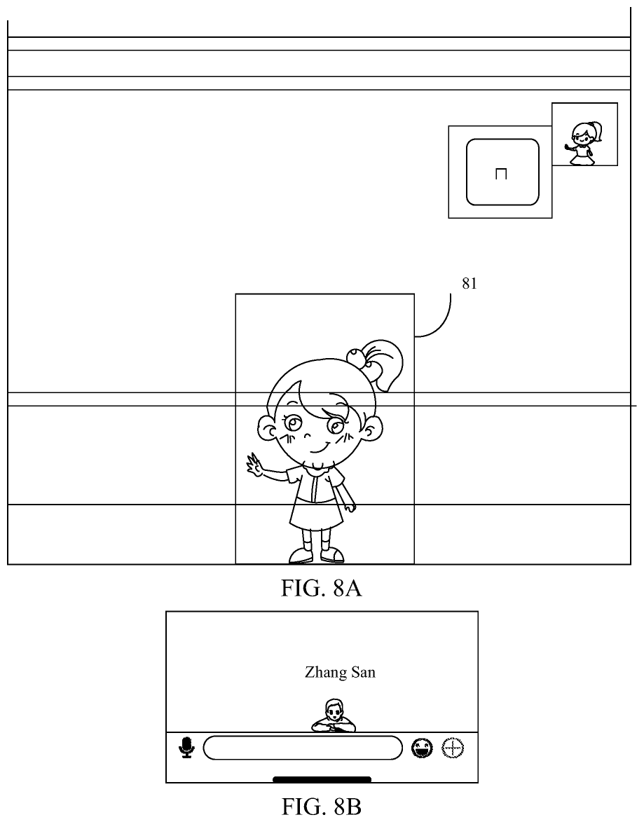

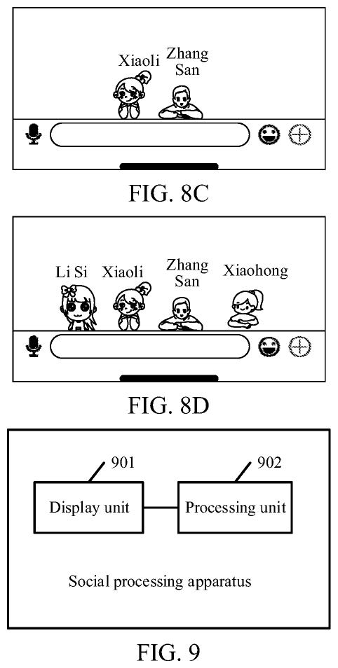

(5) The social client starts a rendering engine to render the avatar according to the feature information of the to-be-displayed j^{th} avatar, calls the character action player to record the to-be-displayed j^{th} avatar, and finally synthesizes the dynamic image resource of the to-be-displayed j^{th} avatar, for example, as shown in FIG. 8A, records the to-be-displayed avatar 81 in the character action player; and then calls the character action player to play and display the j^{th} avatar based on the dynamic image resource of the synthesized to-be-displayed j^{th} avatar.

It should be understood that the character action player is a general avatar playback capability, and only provides a display capability of the avatar for a single social object, which facilitates reuse and expansion of service capabilities. The character action player also supports interactive interactions such as clicking and touching and holding, which may be configured for expanding interaction options such as service capabilities such as a special reminder, messaging through private chat, and adding a relationship. Through the character action player, display of the M avatars may be implemented and interaction is implemented through the avatar.

Under the premise of a character action player of a single social object, an avatar of each social object may correspond to one character action player. Character action players corresponding to avatars of each social object are combined and arranged according to a display order (or display priority order) of configuration information or an interaction behavior of the user to form M avatar floating layers. In addition, service configuration may be flexibly performed. In some embodiments, as shown in FIG. 8B, only one avatar floating layer (in other words, the avatar floating layer of the target social object is displayed) of a social object may be formed through display management. In some embodiments, as shown in FIG. 8C, an avatar floating layer (in other words, an avatar of the target social object and an avatar of another social object (friend)) of two social objects may be displayed through display management. In some embodiments, as shown in FIG. 8D, a plurality of avatar floating layers (in other words, the avatar of the target social object and the avatars of the plurality of social objects are displayed) are displayed in the session interface.

FIG. 9 is a schematic diagram of a structure of a social processing apparatus according to some embodiments. The social processing apparatus may be a computer program (including program code) run in a computer device. For example, the social processing apparatus may be an application software in the computer device; and the social processing apparatus may be configured to perform some or all of the steps in the method embodiments shown in FIG. 2 and FIG. 5. Referring to FIG. 9, the social processing apparatus includes the following units:
a display unit 901, configured to display a session interface of a social session, the social session including N social objects, and each social object having an avatar of the social object; and N being an integer greater than 1;
a processing unit 902, configured to obtain configuration information for the avatar, the configuration information being configured for configuring M to-be-displayed avatars in N avatars; and M being an integer and M being less than or equal to N; and
the display unit 901, further configured to display the M avatars in the session interface according to the configuration information.

In some embodiments, any one of the N social objects is represented as an i^{th} social object, and i is an integer and i is less than or equal to N; an object identifier of the i^{th} social object is displayed in the session interface; and when obtaining configuration information for the avatar, the processing unit 902 may be configured to:
receive a trigger operation performed on the object identifier of the i^{th} social object; and
configure an avatar of the i^{th} social object as a to-be-displayed avatar based on the trigger operation, where
the trigger operation includes any one of the following: clicking the object identifier of the i^{th} social object; and moving the object identifier of the i^{th} social object in the session interface; touching and holding the object identifier of the i^{th} social object; and calling out a menu through the object identifier of the i^{th} social object, and selecting a to-be-displayed option from the menu.

In some embodiments, the configuration information is further configured for configuring an avatar that needs to be blocked; any one of the M avatars is represented as a j^{th} avatar, and j is an integer and j is less than or equal to M; and when obtaining configuration information for the avatar, the processing unit 902 may be configured to:
receive a removal operation performed on the j^{th} avatar; and
configure, based on the removal operation, the j^{th} avatar as the avatar that needs to be blocked, where
the removal operation includes any one of the following: clicking the j^{th} avatar; moving the j^{th} avatar in the session interface; touching and holding the j^{th} avatar; and calling out a menu through the j^{th} avatar, and selecting an option that needs to be blocked from the menu.

In some embodiments, any one of the N social objects is represented as an i^{th} social object, and i is an integer and i is less than or equal to N; when obtaining configuration information for the avatar, the processing unit 902 may be configured to:
obtain social attribute information of the i^{th} social object; and
configure an avatar of the i^{th} social object as a to-be-displayed avatar in a case that the social attribute information of the i^{th} social object meets a preset condition, where
the social attribute information of the i^{th} social object includes at least one of the following: a social activity level of the i^{th} social object in the social session; an interaction frequency between the i^{th} social object and each of the other social objects in the social session; and an interaction relationship between the i^{th} social object and each of the other social objects in the social session.

In some embodiments, the social attribute information of the i^{th} social object includes: a social activity level of the i^{th} social object in the social session; when configuring an avatar of the i^{th} social object as a to-be-displayed avatar in a case that the social attribute information of the i^{th} social object meets a preset condition, the processing unit 902 may be configured to:
configure the avatar of the i^{th} social object as the to-be-displayed avatar in a case that the social activity level of the i^{th} social object in the social session is greater than an activity threshold, where
the social activity level of the i^{th} social object in the social session includes at least one of the following: a quantity of messages transmitted by the i^{th} social object in the social session in a preset time period; joining duration of the i^{th} social object that joins the social session; online duration of the i^{th} social object; and a quantity of times that the i^{th} social object participates in a social topic in the social session.

In some embodiments, the social attribute information of the i^{th} social object includes: an interaction frequency between the i^{th} social object and each of the other social objects in the social session; and when configuring an avatar of the i^{th} social object as a to-be-displayed avatar in a case that the social attribute information of the i^{th} social object meets a preset condition, the processing unit 902 may be configured to:
configure the avatar of the i^{th} social object as the to-be-displayed avatar in a case that the interaction frequency between the i^{th} social object and each of the other social objects in the social session is greater than a frequency threshold, where
the interaction frequency between the i^{th} social object and each of the other social objects in the social session includes at least one of the following: a frequency at which the i^{th} social object likes each of the other social objects; a frequency at which the i^{th} social object comments on each of the other social objects; a frequency at which the i^{th} social object enters social space of each of the other social objects to perform visiting; and a frequency at which the i^{th} social object performs message exchange with each of the other social objects in the session interface.

In some embodiments, the social attribute information of the i^{th} social object includes: an interaction relationship between the i^{th} social object and each of the other social objects in the social session, where when configuring an avatar of the i^{th} social object as a to-be-displayed avatar in a case that the social attribute information of the i^{th} social object meets a preset condition, the processing unit 902 may be configured to:
configure the avatar of the i^{th} social object as the to-be-displayed avatar in a case that a latest message transmitted by the i^{th} social object in the social session is in a preset order range in a message flow of the social session, or a time difference between a transmitting time point at which the i^{th} social object transmits a latest message in the social session and a transmitting time point at which a target social object in the social session transmits a latest message is in a preset time range, where
the interaction relationship between the i^{th} social object and each of the other social objects in the social session includes any one of the following: an order relationship between a message transmitted by the i^{th} social object in the social session and messages transmitted by each of the other social objects in the social session; and a time difference relationship between a transmitting time point at which the i^{th} social object transmits the message in the social session and a transmitting time point at which each of the other social objects transmits the message in the social session; and the target social object is an object requesting the configuration information, and the target social object is any one of each of the other social objects.

In some embodiments, when displaying the M avatars in the session interface according to the configuration information, the display unit 901 may be configured to:
display the M avatars in a target area of the session interface, where
the target area includes any one of the following: any area obtained by dividing the session interface; and an area presented following the session interface but independent of the session interface; and
the target area is directly displayed by default; or the target area is hidden by default, and is triggered to be displayed in a case that there is an area evocation operation.

In some embodiments, the target area includes a plurality of display positions. When displaying the M avatars in a target area of the session interface, the display unit 901 may be configured to:
separately place the M avatars at display positions in the target area for display, where
a display order of the M avatars in the target area includes a random order or a fixed order; and the display order of the M avatars in the target area supports dynamic adjustment.

In some embodiments, when respectively placing the M avatars at display positions in the target area for display, the display unit 901 may be configured to:
separately place, in a case that a quantity of display positions in the target area is greater than or equal to M, the M avatars at the display positions in the target area for display; and
place, in a case that the quantity of display positions in the target area is less than M, some avatars in the M avatars at the display positions of the target area for display, and update, in a case that a switching operation is detected, the avatars at the display positions, to switch display of the M avatars.

In some embodiments, the session interface includes a session area, and the session area is configured for displaying a message flow of the social session; and
a position relationship between the target area and the session area includes any one of the following: the target area and the session area are two areas that are independent of each other; there is an intersection between the target area and the session area; the target area is located in the session area; the session area is located in the target area; and
the display of the avatar in the target area and the display of the message flow in the session area are independent of each other and do not affect each other.

In some embodiments, the configuration information is further configured for configuring a display manner of the M avatars; the display manner includes resident display; and
when displaying the M avatars in the session interface according to the configuration information, the display unit 901 may be configured to:
highlight, according to the configuration information in the session interface, an avatar that needs the resident display in the M avatars, where
the highlighting includes any one or more of the following: enlarging and displaying the avatar that needs the resident display; displaying the avatar that needs the resident display in a target color; adding a resident prompt for the avatar that needs the resident display; and displaying the avatar that needs the resident display at a target position.

In some embodiments, the session interface is located in the social client, and the display unit 901 is further configured to:
display the avatar that needs the resident display in a service interface of the social client; and
display, in a case that the avatar that needs the resident display displayed in the service interface is triggered, an associated interface of the triggered avatar, where
the service interface includes any one of the following: a homepage of the social client, a session list page of the social client, a function page of the social client, and a social relationship chain list page of the social client; and the associated interface of the triggered avatar includes any one of the following: a session interface between a social object corresponding to the triggered avatar and a trigger object, a session interface of a social group to which the social object corresponding to the triggered avatar belongs, and a corresponding session interface in a case that the triggered avatar is configured as resident display.

In some embodiments, the processing unit 902 is further configured to:
manage, in response to a display management operation on a displayed avatar, the display of the M avatars, where
the managing includes any one of the following: synchronously displaying the M avatars, synchronously hiding the M avatars, hiding some avatars in the M avatars, and redisplaying hidden avatars in the M avatars.

In some embodiments, the display unit 901 is further configured to:
update and display, in a case that the configuration information changes, an avatar in the session interface according to changed configuration information.

In some embodiments, when updating and displaying, in a case that the configuration information changes, an avatar in the session interface according to changed configuration information, the display unit 901 may be configured to:
display, each time one to-be-displayed avatar is newly configured in the configuration information, the newly configured avatar in the session interface;
delete, each time one avatar that needs to be blocked is newly configured in the configuration information, the avatar that has been displayed and needs to be blocked in the session interface; and
change, each time a display manner of an avatar is changed in the configuration information, the avatar that has been displayed in the session interface from resident display to non-resident display according to the change, or from non-resident display to resident display.

In some embodiments, any one of the M avatars is represented as a j^{th} avatar, and j is an integer and j is less than or equal to M. The processing unit 902 is further configured to:
interact with, in response to an interaction operation performed by a target social object on the j^{th} avatar, a social object corresponding to the j^{th} avatar.

In some embodiments, when interacting with, in response to an interaction operation performed by a target social object on the j^{th} avatar, a social object corresponding to the j^{th} avatar, the processing unit 902 may be configured to:
display an interaction option list in response to the interaction operation performed by the target social object on the j^{th} avatar, where the interaction option list includes one or more interaction options, and the interaction options include one of the following: a special reminder option, a separate session option, a relationship adding option, a virtual space option, and a mini program interaction option; and
select the interaction option from the interaction option list, and perform interaction indicated by the selected interaction option between the target social object and the social object corresponding to the j^{th} avatar.

In some embodiments, in a case that the selected interaction option is the special reminder option, the interaction is transmitting a social message in the session interface, and the social message includes a special reminder identifier and an object identifier of the social object corresponding to the j^{th} avatar;
in a case that the selected interaction option is the separate session option, the interaction is displaying a separate session interface between the target social object and the social object corresponding to the j^{th} avatar;
in a case that the selected interaction option is the relationship adding option, the interaction is adding the object identifier of the social object corresponding to the j^{th} avatar to a social relationship chain of the target social object;
in a case that the selected interaction option is the virtual space option, the interaction is displaying virtual space between the j^{th} avatar and the target social object; or the interaction is that the target social object joins virtual space of the social object corresponding to the j^{th} avatar; or the interaction is that the social object corresponding to the j^{th} avatar joins virtual space of the target social object; and
in a case that the selected interaction option is the mini program interaction option, the interaction is that the target social object enters a mini program interface of the social object corresponding to the j^{th} avatar; or the interaction is that the social object corresponding to the j^{th} avatar enters a mini program interface of the target social object.

In some embodiments, the processing unit 902 is further configured to: output, following the interaction, an animation that matches the interaction.

In some embodiments, when outputting, following the interaction, an animation that matches the interaction, the processing unit 902 may be configured to:
play, following the interaction, a prompt animation that matches interactive content in the session interface; or
control, following the interaction, an avatar corresponding to the target social object or the j^{th} avatar to execute the animation that matches the interactive content.

In some embodiments, a session interface of a social session is displayed, the social session including N social objects, and each social object having an avatar of the social object; and N being an integer greater than 1; configuration information for the avatar is obtained, the configuration information being configured for configuring M to-be-displayed avatars in N avatars; and M being an integer and M being less than or equal to N; and the M avatars are displayed in the session interface according to the configuration information. Information configuration is performed on an avatar and the avatar is displayed, so that the avatar may be more flexibly used in a social scene (especially a social session scene), thereby meeting a personalized requirement of a social object.

A person skilled in the art would understand that the above “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

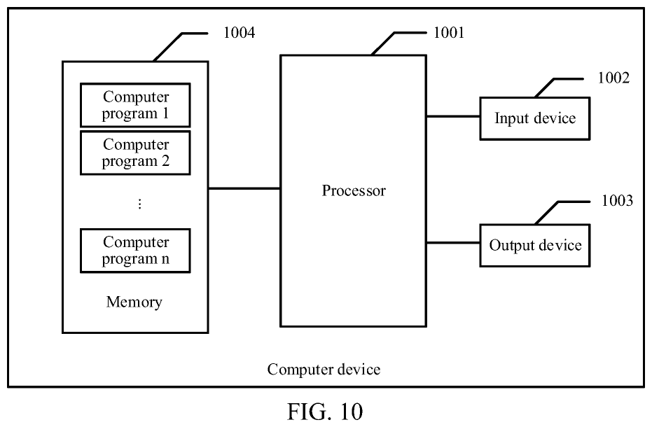

FIG. 10 illustrates a schematic diagram of a structure of a computer device according to some embodiments. In some embodiments, the computer device may include: a processor 1001, an input device 1002, an output device 1003, and a memory 1004. The processor 1001, the input device 1002, the output device 1003, and the memory 1004 are connected through a bus. The memory 1004 is configured to store a computer program. The computer program includes program instructions. The processor 1001 is configured to execute the program instructions stored in the memory 1004.

In some embodiments, the processor 1001 performs the following operations by running the executable program code in the memory 1004:
displaying a session interface of a social session, the social session including N social objects, and each social object having an avatar of the social object; and N being an integer greater than 1;
obtaining configuration information for the avatar, the configuration information being configured for configuring M to-be-displayed avatars in N avatars; and M being an integer and M being less than or equal to N; and
displaying the M avatars in the session interface according to the configuration information.

In some embodiments, a session interface of a social session is displayed, where the social session includes N social objects, and each social object has an avatar of the social object; and N is an integer greater than 1; configuration information for the avatar is obtained, the configuration information being configured for configuring M to-be-displayed avatars in N avatars; and M being an integer and M being less than or equal to N; and the M avatars are displayed in the session interface according to the configuration information. Information configuration is performed on an avatar and the avatar is displayed, so that the avatar may be more flexibly used in a social scene (especially a social session scene), thereby meeting a personalized requirement of a social object.

In addition, some embodiments provide a non-transitory computer-readable storage medium. The computer-readable storage medium stores a computer program executed by the data processing apparatus mentioned above, and the computer program includes program instructions. When executing the program instructions, the processor may perform the method in the embodiments corresponding to FIG. 2 and FIG. 5. Therefore, details are not repeated herein. For technical details that are not disclosed in the embodiments of the computer-readable storage medium, refer to the method embodiments. In an example, the program instructions may be deployed to be executed on a computer device, or deployed to be executed on a plurality of computer devices at the same location, or deployed to be executed on a plurality of computer devices that are distributed in a plurality of locations and interconnected by a communication network.

According to some embodiments, a computer program product is provided, including a computer program, the computer program being stored in a computer-readable storage medium. A processor of a computer device reads the computer program from the computer-readable storage medium and executes the computer program, to enable the computer device to perform the method in the foregoing embodiments corresponding to FIG. 2 and FIG. 5. Therefore, details are not repeated herein.

A person of ordinary skill in the art may understand that all or some of the processes of the methods in the foregoing embodiments may be implemented by a computer program instructing relevant hardware. The program may be stored in a computer-readable storage medium. During execution of the program, processes of the foregoing method embodiments may be included. The storage medium may be a magnetic disk, an optical disc, a read-only memory (ROM), a random access memory (RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A social processing method, performed by a computer device, comprising:
displaying a session interface of a social session comprising N social objects, N being an integer greater than 1, and each social object having an avatar, the avatar being an image configured for interacting with other social objects through an interaction behavior;
obtaining configuration information, the configuration information being information on M avatars to-be-displayed of N avatars, and M being an integer less than or equal to N; and
displaying the M avatars in the session interface according to the configuration information.

2. The social processing method according to claim 1, wherein any one of the N social objects is represented as an i^{th} social object, and i is an integer less than or equal to N;
wherein an object identifier of the i^{th} social object is displayed in the session interface; and
wherein obtaining the configuration information comprises:
receiving a trigger operation performed on the object identifier of the i^{th} social object; and
configuring the avatar of the i^{th} social object as an avatar to-be-displayed based on the trigger operation, wherein
the trigger operation comprises any one of the following: clicking the object identifier of the i^{th} social object; moving the object identifier of the i^{th} social object in the session interface; touching and holding the object identifier of the i^{th} social object; and calling out a menu through the object identifier of the i^{th} social object, and selecting a to-be-displayed option from the menu.

3. The social processing method according to claim 1, wherein the configuration information includes information on an avatar that needs to be blocked; any one of the M avatars is represented as a j^{th} avatar, and j is an integer less than or equal to M; and
wherein obtaining the configuration information comprises:
receiving a removal operation performed on the j^{th} avatar; and
configuring, based on the removal operation, the j^{th} avatar as the avatar that needs to be blocked, wherein
the removal operation comprises any one of the following: clicking the j^{th} avatar; moving the j^{th} avatar in the session interface; touching and holding the j^{th} avatar; and calling out a menu through the j^{th} avatar, and selecting an option that needs to be blocked from the menu.

4. The social processing method according to claim 1, wherein any one of the N social objects is represented as an i^{th} social object, and i is an integer is less than or equal to N; and
wherein obtaining the configuration information comprises:
obtaining social attribute information of the i^{th} social object; and
configuring an avatar of the i^{th} social object as a to-be-displayed avatar in a case that the social attribute information of the i^{th} social object meets a preset condition, wherein
the social attribute information of the i^{th} social object comprises at least one of the following: a social activity level of the i^{th} social object in the social session; an interaction frequency between the i^{th} social object and each of the other social objects in the social session; and an interaction relationship between the i^{th} social object and each of the other social objects in the social session.

5. The social processing method according to claim 4, wherein the social attribute information of the i^{th} social object comprises: a social activity level of the i^{th} social object in the social session; and
wherein configuring the avatar of the i^{th} social object as the to-be-displayed avatar based on the social attribute information of the i^{th} social object meeting the preset condition comprises:
configuring the avatar of the i^{th} social object as the to-be-displayed avatar based on the social activity level of the i^{th} social object in the social session being greater than an activity threshold, wherein
the social activity level of the i^{th} social object in the social session comprises at least one of the following: a quantity of messages transmitted by the i^{th} social object in the social session in a preset time period; joining duration of the i^{th} social object that joins the social session; online duration of the i^{th} social object; and a quantity of times that the i^{th} social object participates in a social topic in the social session.

6. The social processing method according to claim 4, wherein the social attribute information of the i^{th} social object comprises: an interaction frequency between the i^{th} social object and each of the other social objects in the social session; and
wherein configuring the avatar of the i^{th} social object as the to-be-displayed avatar based on the social attribute information of the i^{th} social object meeting the preset condition comprises:
configuring the avatar of the i^{th} social object as the to-be-displayed avatar based on the interaction frequency between the i^{th} social object and each of the other social objects in the social session being greater than a frequency threshold, wherein
the interaction frequency between the i^{th} social object and each of the other social objects in the social session comprises at least one of the following: a frequency at which the i^{th} social object likes each of the other social objects; a frequency at which the i^{th} social object comments on each of the other social objects; a frequency at which the i^{th} social object enters social space of each of the other social objects to perform visiting; and a frequency at which the i^{th} social object performs message exchange with each of the other social objects in the session interface.

7. The social processing method according to claim 4, wherein the social attribute information of the i^{th} social object comprises: the interaction relationship between the i^{th} social object and each of the other social objects in the social session; and
wherein configuring the avatar of the i^{th} social object as the to-be-displayed avatar based on the social attribute information of the i^{th} social object meeting the preset condition comprises:
configuring the avatar of the i^{th} social object as the to-be-displayed avatar based on a latest message transmitted by the i^{th} social object in the social session being in a preset order range in a message flow of the social session, or a time difference between a transmitting time point at which the i^{th} social object transmits a latest message in the social session and a transmitting time point at which a target social object in the social session transmits a latest message being in a preset time range, wherein
the interaction relationship between the i^{th} social object and each of the other social objects in the social session comprises any one of the following: an order relationship between a message transmitted by the i^{th} social object in the social session and messages transmitted by each of the other social objects in the social session; and a time difference relationship between a transmitting time point at which the i^{th} social object transmits the message in the social session and a transmitting time point at which each of the other social objects transmits the message in the social session; and the target social object is an object requesting the configuration information, and the target social object is any one of each of the other social objects.

8. The social processing method according to claim 1, wherein displaying the M avatars in the session interface according to the configuration information comprises:
displaying the M avatars in a target area of the session interface, the target area comprising any one of the following: any area obtained by dividing the session interface; and an area presented following the session interface but independent of the session interface; and
wherein the target area is directly displayed by default; or the target area is hidden by default, and is triggered to be displayed based on an area evocation operation.

9. The social processing method according to claim 8, wherein the target area comprises a plurality of display positions, and
wherein displaying the M avatars in the target area of the session interface comprises:
respectively placing the M avatars at display positions in the target area for display, a display order of the M avatars in the target area comprising a random order or a fixed order; and the display order of the M avatars in the target area supporting dynamic adjustment.

10. The social processing method according to claim 9, wherein respectively placing the M avatars at the display positions in the target area for display comprises:
respectively placing, based on a quantity of display positions in the target area being greater than or equal to M, the M avatars at the display positions in the target area for display; and
placing, based on the quantity of display positions in the target area being less than M, some avatars in the M avatars at the display positions of the target area for display, and updating, in based on a switching operation, the display positions to switch display of the M avatars.

11. The social processing method according to claim 8, wherein the session interface comprises a session area, and the session area is configured for displaying a message flow of the social session;
a position relationship between the target area and the session area comprises any one of the following: the target area and the session area are two areas that are independent of each other; there is an intersection between the target area and the session area; the target area is located in the session area; the session area is located in the target area; and
the display of the avatar in the target area and the display of the message flow in the session area are independent of each other and do not affect each other.

12. The social processing method according to claim 1, wherein the configuration information further includes a display manner of the M avatars; the display manner comprises resident display; and
wherein displaying the M avatars in the session interface according to the configuration information comprises:
highlighting, according to the configuration information in the session interface, an avatar of the M avatars that needs the resident display, wherein
the highlighting comprises any one or more of the following: enlarging and displaying the avatar that needs the resident display; displaying the avatar that needs the resident display in a target color; adding a resident prompt for the avatar that needs the resident display; and displaying the avatar that needs the resident display at a target position.

13. The social processing method according to claim 12, wherein the session interface is located in a social client, and the social processing method further comprises:
displaying the avatar that needs the resident display in a service interface of the social client; and
displaying, based on the avatar that needs the resident display displayed in the service interface being triggered, an associated interface of the triggered avatar, wherein
the service interface comprises any one of the following: a homepage of the social client, a session list page of the social client, a function page of the social client, and a social relationship chain list page of the social client; and the associated interface of the triggered avatar comprises any one of the following: a session interface between a social object corresponding to the triggered avatar and a trigger object, a session interface of a social group to which the social object corresponding to the triggered avatar belongs, and a corresponding session interface in a case that the triggered avatar is configured as resident display.

14. The social processing method according to claim 1, further comprising:
managing, based on a display management operation on a displayed avatar, the display of the M avatars, wherein
the managing comprises any one of the following: synchronously displaying the M avatars, synchronously hiding the M avatars, hiding some avatars in the M avatars, and redisplaying hidden avatars in the M avatars.

15. The social processing method according to claim 1, further comprising:
updating and displaying, based on changes to the configuration information, an avatar in the session interface according to changed configuration information.

16. The social processing method according to claim 15, wherein updating and displaying, based on changes to the configuration information, the avatar in the session interface according to the changed configuration information comprises:
displaying, each time one to-be-displayed avatar is newly configured in the configuration information, the newly configured avatar in the session interface;
deleting, each time one avatar that needs to be blocked is newly configured in the configuration information, the avatar that has been displayed and needs to be blocked in the session interface; and
changing, each time a display manner of the avatar is changed in the configuration information, the avatar that has been displayed in the session interface from resident display to non-resident display according to the change, or from non-resident display to resident display.

17. The social processing method according to claim 1, wherein any one of the M avatars is represented as a j^{th} avatar, j is an integer and j is less than or equal to M, and the social processing method further comprises:
interacting with, based on an interaction operation performed by a target social object on the j^{th} avatar, a social object corresponding to the j^{th} avatar.

18. The social processing method according to claim 17, wherein interacting with the social object corresponding to the j^{th} avatar comprises:
displaying an interaction option list based on the interaction operation performed by the target social object on the j^{th} avatar, wherein the interaction option list comprises one or more interaction options, and the interaction options comprise one of the following: a special reminder option, a separate session option, a relationship adding option, a virtual space option, and a mini program interaction option; and
selecting the interaction option from the interaction option list, and performing interaction indicated by the selected interaction option between the target social object and the social object corresponding to the j^{th} avatar.

19. A social processing apparatus, comprising:
at least one memory configured to store program code; and
at least one processor configured to read the program code and operate as instructed by the program code, the program code comprising:
display code configured to cause at least one of the at least one processor to display a session interface of a social session comprising N social objects, N being an integer greater than 1, and each social object having an avatar;
processing code configured to cause at least one of the at least one processor to obtain configuration information, the configuration information being information on M avatars to-be-displayed of N avatars and M being an integer less than or equal to N; and
wherein the display code is further configured to cause at least one of the at least one processor to display the M avatars in the session interface according to the configuration information.

20. A non-transitory computer-readable storage medium storing
display a session interface of a social session comprising N social objects, N being an integer greater than 1, and each social object having an avatar, the avatar being an image configured for interacting with other social objects through an interaction behavior;
obtain configuration information for the avatar, the configuration information being information on M avatars to-be-displayed of N avatars; and M being an integer less than or equal to N; and
display the M avatars in the session interface according to the configuration information.
